(19) United States
(12) Patent Application Publication
(10) Pub. No.: US 2026/0228451 A1
(43) Pub. Date: Aug. 6, 2026

(54) Autonomous Artificial Intelligence Agent Determination Based On Database Records In A Database System

(71) Applicant: Salesforce, Inc., San Francisco, CA (US)

(72) Inventors: Henry Wallace, Frederick, MA (US); Asif Ali, San Francisco, CA (US); Keld Lundgaard, Belmont, MA (US); Aashish Jain, Cambridge, MA (US)

(21) Appl. No.: 19/096,270

(22) Filed: Mar. 31, 2025

Related U.S. Application Data
(60) Provisional application No. 63/752,535, filed on Jan. 31, 2025.

(51) Int. Cl. G06F 40/40; G06F 16/28

(52) U.S. Cl. CPC G06F 40/40; G06F 16/284

(57) ABSTRACT

A computing services environment may include a relational database system storing database records corresponding to text-based interactions between individuals and human agents, a unified metadata framework including a plurality of autonomous agent definitions, an agent creation engine, an agent service, and an orchestration layer. The agent creation engine may create and store an autonomous agent definition in accordance with the unified metadata framework by iteratively selecting a database record from the plurality of database records and determining autonomous agent definition update information based on text included in the database record. The autonomous agent definition may reference a plurality of action definitions defining a plurality of actions capable of being performed within the computing services environment. The agent service may instantiate an autonomous agent instance based on the autonomous agent definition. The orchestration layer may determine an orchestration plan based on the autonomous agent definition.

### CROSS-REFERENCE TO RELATED APPLICATIONS

This application claims the benefit under 35 U.S.C. § 119(e) of U.S. Provisional Patent Application 63/752,535 (Attorney Docket No. SFDCP253P) by Wallace et al., titled: “Autonomous Artificial Intelligence Agent Determination Based on Database Records In A Database System”, filed on Jan. 31, 2025, which is incorporated herein by reference in its entirety for all purposes.

### FIELD OF TECHNOLOGY

This patent application relates generally to database systems, and more specifically to autonomous artificial intelligence agents implemented in the context of database systems.

### BACKGROUND

Autonomous artificial intelligence agents take advantage of recent advances in large language models to generate novel text, interact with people, and perform various types of operations with minimal or no oversight. Autonomous artificial intelligence agents typically rely on one or more standard large language models. Such models are typically not tuned for a particular purpose, but rather are used in a variety of applications. Like humans, however, large language models are capable of a wide range of behaviors, whereas a provider of an autonomous artificial intelligence agent would generally prefer that the agent behave in particular ways.

Accordingly, creating an autonomous artificial intelligence agent using conventional techniques involves manually crafting prompts and natural language instructions. Even after such a manual process, the autonomous artificial intelligence agent will be imperfectly adapted to its intended purpose. For instance, different people may configure an autonomous artificial intelligence agent in very different ways, leading to different performance in different situations. Accordingly, improved techniques for the configuration of autonomous artificial intelligence agents are desired.

### BRIEF DESCRIPTION OF THE DRAWINGS

The included drawings are for illustrative purposes and serve only to provide examples of possible structures and operations for the disclosed inventive systems, apparatus, methods, and computer program products for artificial intelligence agent creation based on database records in a database system. These drawings in no way limit any changes in form and detail that may be made by one skilled in the art without departing from the spirit and scope of the disclosed implementations.

FIG. 1 illustrates an autonomous artificial intelligence agent lifecycle method, performed in accordance with one or more embodiments.

FIG. 2 illustrates various elements that may be included within a computing services environment, configured in accordance with one or more embodiments.

FIG. 3 illustrates a method for creating an autonomous agent, performed in accordance with one or more embodiments.

FIG. 4 illustrates a method of creating an autonomous agent patch, performed in accordance with one or more embodiments.

FIG. 5 illustrates a user interface through which a simple interaction with an autonomous agent trained in accordance with one or more embodiments is shown.

FIG. 6 illustrates a computing services environment, configured in accordance with one or more embodiments.

FIG. 7 illustrates a method providing an overview of the lifecycle of an autonomous agent, performed in accordance with one or more embodiments.

FIG. 8 illustrates a trust model for the autonomous agent platform, configured in accordance with one or more embodiments.

FIG. 9 illustrates an architecture diagram of elements of the computing services environment, configured in accordance with one or more embodiments.

FIG. 10 shows a block diagram of an example of an environment that includes an on-demand database service configured in accordance with some implementations.

FIG. 11A shows a system diagram of an example of architectural components of an on-demand database service environment, configured in accordance with some implementations.

FIG. 11B shows a system diagram further illustrating an example of architectural components of an on-demand database service environment, in accordance with some implementations.

FIG. 12 illustrates one example of a computing device, configured in accordance with one or more embodiments.

### DETAILED DESCRIPTION

### Introduction

According to various embodiments, an autonomous agent may be defined based on a set of resources such as one or more prompt templates, action definitions, reasoning frameworks, and the like. The autonomous agent may be instantiated at runtime by an agent service at a computing services environment. Executing the autonomous agent may involve operations such as transmitting a planning prompt to a generative language model. The planning prompt may include both input data and natural language instructions to be executed by the generative language model. The input data may include, for instance, one or more chat utterances, data retrieved from a database system or other such sources, and/or other types of initialization information. The generative language model may then execute natural language instructions in the planning prompt to determine novel text based on the input data. The novel text may include action identifiers corresponding to action definitions. The computing services environment may then execute the natural language instructions to include novel text. The novel text may include identifiers corresponding to actions that may be taken within the computing services environment. Alternatively, or additionally, the novel text may include response text to be provided to a user, for instance via a chat interface. The computing services environment may then execute the actions corresponding to the action identifiers.

In some embodiments, techniques and mechanisms described herein may provide for automatic curation of high-level patterns seen in chat, topic instructions, action JSON schemas, test cases, regression tests, and other such elements. A set of chat records reflecting conversations related to a topic may be progressively analyzed to train an autonomous agent to behave in a manner similar to a human agent.

Conventional approaches to defining agents in such a framework are largely manual processes. For instance, an administrator must manually specify the prompts, action definitions, data retrievers, and the like. In addition to being largely manual, such processes are often incomplete. For instance, the natural language instructions manually provided by the administrator may fail to address various situations that the autonomous agent may encounter, leading to sub-optimal performance of the autonomous agent.

In contrast to these conventional approaches, various embodiments described herein provide for an automated process of training an autonomous agent based on chat records between users and human agents. In some embodiments, the process for training the autonomous agent may involve LLM-managed state updates. For instance, the JSON PATCH RFC 6902 may be coupled with a strategy of grouping reasoning, which avoids the context scale bottleneck for large datasets needed to effectively train an autonomous agent. The JSON scheme may be used for structured reasoning as a way to decompose complex problems into sub-parts of a schema generation. Simulated flows of agent interactions may be used to improve learning of actions. A pipeline of autonomous agent steps may be used to converge multiple chat transcript example batches on a stable set of instructions, actions, and other elements for an autonomous agent and associated planner. A reflection and debug mode may be used to improve various elements of the pipeline.

In some approaches to training a system for generating natural language, a large corpus of language documents are analyzed at the same time to determine the trained model. However, in the context of an autonomous agent trained to identify and execute actions within a computing services environment, such an approach risks producing an autonomous agent definition with a large set of highly granular actions. However, such an autonomous agent may be unduly large. Further, an autonomous agent instantiated based on such a definition may perform poorly for the much same reasons as overfitted predictive machine learning models. In contrast to such an approach, techniques and mechanisms described herein may facilitate the development of an autonomous agent definition with a limited set of actions. By iteratively evaluating chat records, the resulting autonomous agent definition may be progressively consolidated into smaller sets of actions, such as 10-15 actions for even a very large training data containing potentially hundreds of thousands or millions of chat records.

### Overview

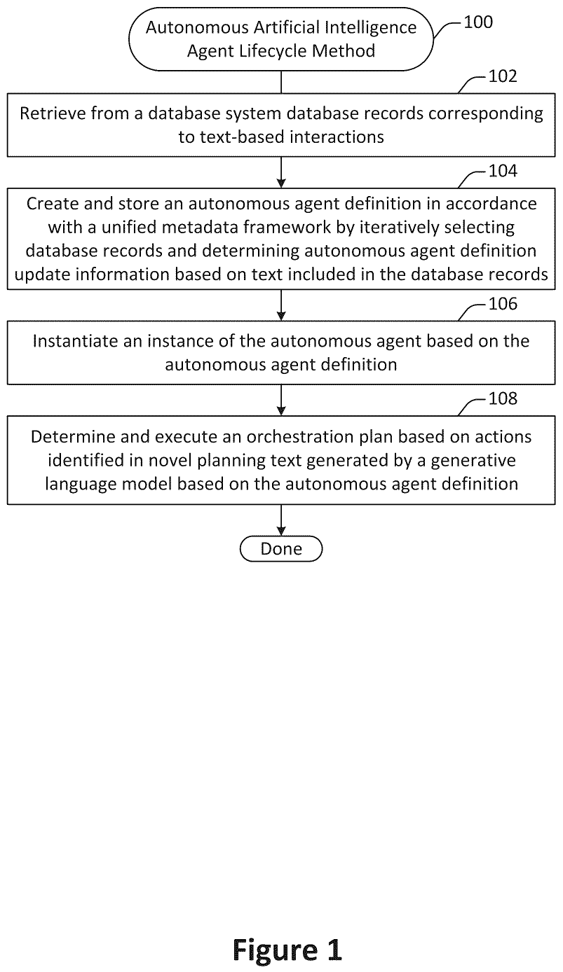

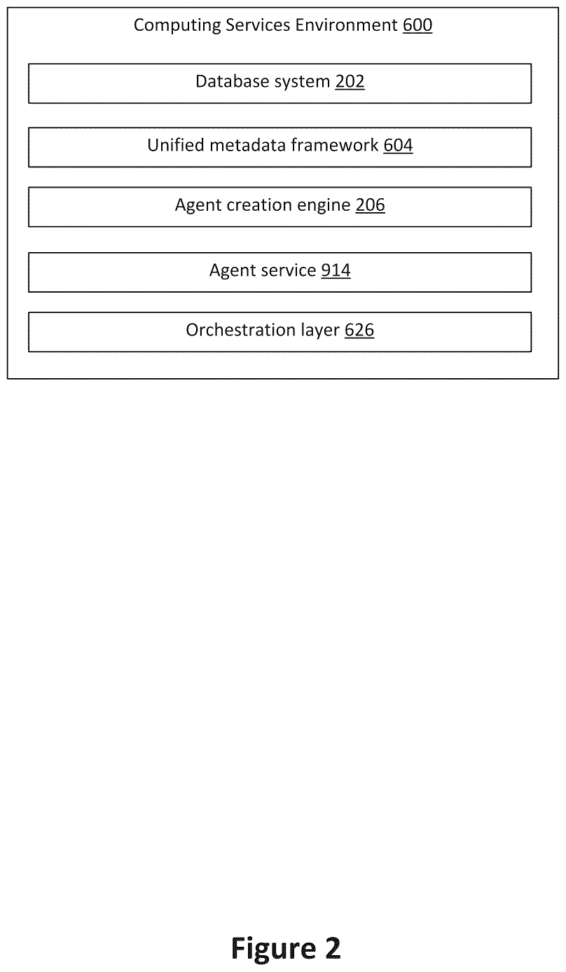

FIG. 1 illustrates an autonomous artificial intelligence agent lifecycle method 100, performed in accordance with one or more embodiments. According to various embodiments, the various operations shown in FIG. 1 may be performed in the course of configuring, instantiating, and executing an autonomous artificial intelligence agent (referred to herein as an autonomous agent). The method 100 may be performed at a computing services environment. The method 100 is described partially in reference to FIG. 2, which illustrates various elements that may be included within a computing services environment 600.

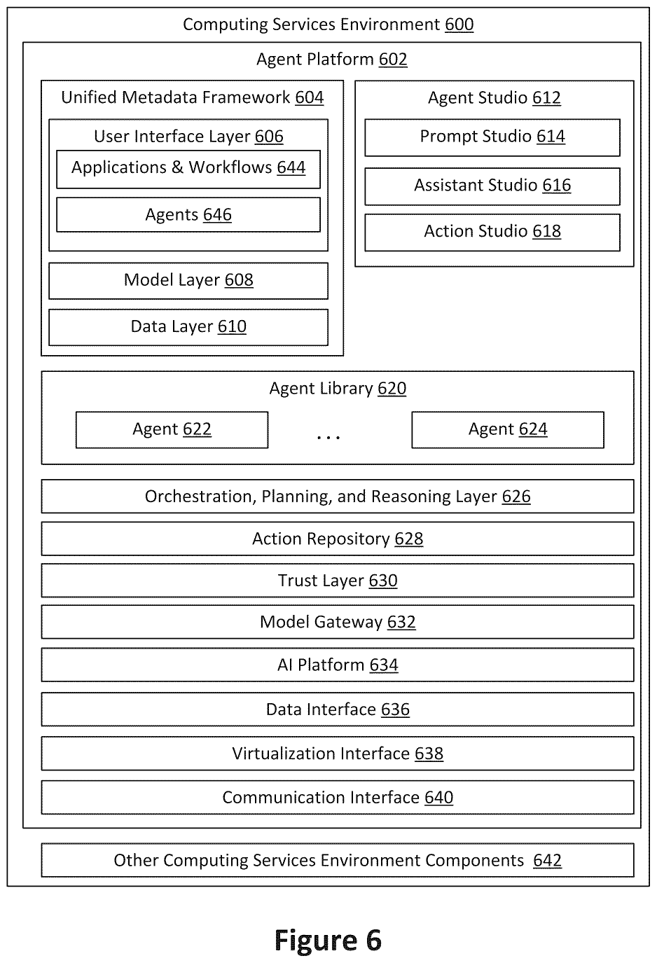

Computing services environments are typically quite complex and include many components working in concert. Although not all of those components are described in this application so as not to obscure the various concepts, additional details regarding various other components that may be included within the computing services environment 600 are shown in FIG. 6, and particularly those components pertinent to the configuration, provisioning, instantiation, and execution of autonomous agents.

Database records are retrieved from a database system at 102. In some embodiments, the database records may correspond to text-based interactions between individuals and human agents. For example, the computing services environment may support one or more applications through which human agents working on behalf of one or more organizations provide services to individuals. Such services may involve sales operations, customer service operations, or other such business-related operations. As shown in FIG. 2, the computing services environment 600 includes a database system 202 that may store the records retrieved at 102 as well as other types of information.

In some embodiments, in the course of providing such services, a human agent may communicate with an individual, such as an actual or potential customer of an organization. Depending on the interaction, such communication may be conducted via voice, text, video, other types of communication channels, or a combination thereof. Records of such interactions may be stored in the database system.

In some embodiments, records of interactions may include text. For example, text may include utterances generated by the individual and/or by the human agent that are transmitted via a chat interface, a text messaging interface, or some other communication interface. As another example, text may be created by converting audio data to text via a speech recognition model.

In some embodiments, records of interactions may include multi-modal data. For instance, interaction records may include or reference video, audio, image, and/or other types of data.

In some embodiments, interaction records may include metadata. A potentially wide range of metadata may be included. For example, metadata may indicate status or resolution information for an interaction, such as whether an incident was successfully resolved. As another example, metadata may identify and/or characterize an organization, human agent, and/or individual associated with an interaction. For instance, a classification of a human agent as a star performer, a trainee, or another type of classification may be included. As yet another example, metadata may identify a topic, product, service, or other such classifier associated with an interaction.

An autonomous agent definition is created and stored in accordance with a unified metadata framework at 104. According to various embodiments, the unified metadata framework 604 may provide a structure for defining resources used to create agents. Various types of resources may be included in an autonomous agent definition. For example, prompt templates may be used to create prompts to provide to generative language models. As another example, action definitions may support the selection and performance of actions such as retrieving data, storing data, generating text, and/or other types of actions executable within the computing services environment. As yet another example, orchestration information may be used to select and implement orchestration plans for selecting actions appropriate to a particular situation being handled by an instance of the autonomous agent.

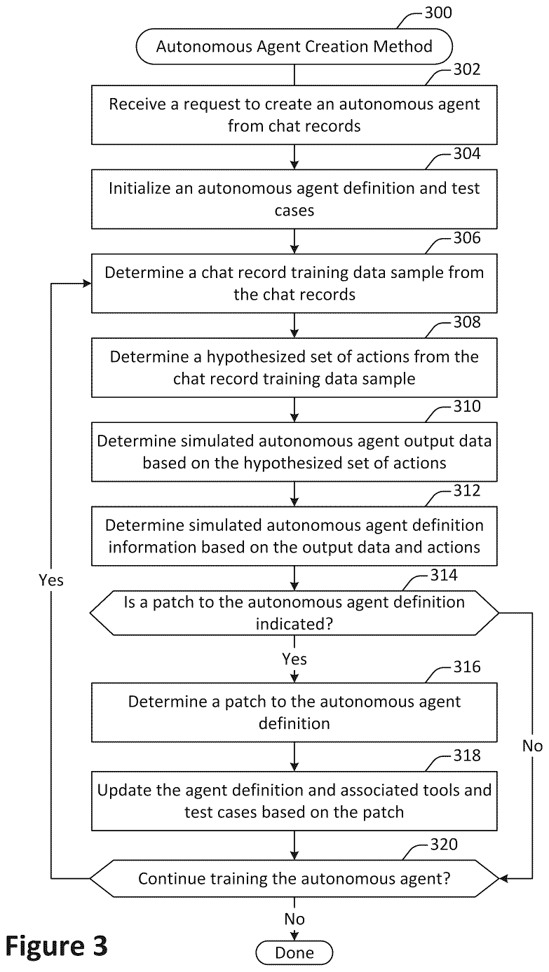

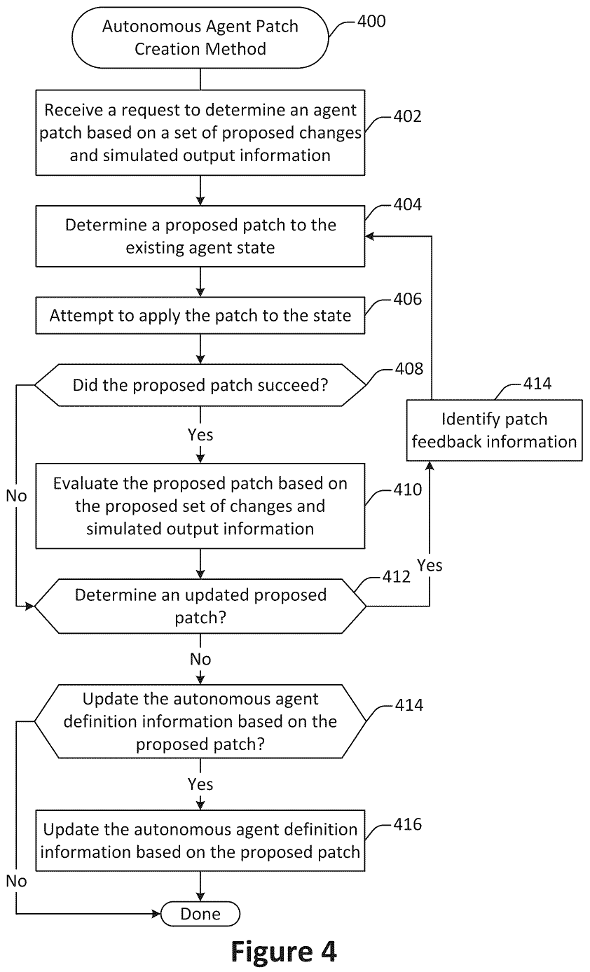

According to various embodiments, the autonomous agent definition may be created and stored by iteratively selecting database records and determining autonomous agent definition update information based on text included in the database records. The agent definition may reference various action definitions defining actions capable of being performed via the computing services environment. The autonomous agent definition may be created and stored via the agent creation engine 206 shown in FIG. 2. Additional details regarding the creation of the autonomous agent definition are discussed with respect to the methods 300 and 400 shown in FIG. 3 and FIG. 4.

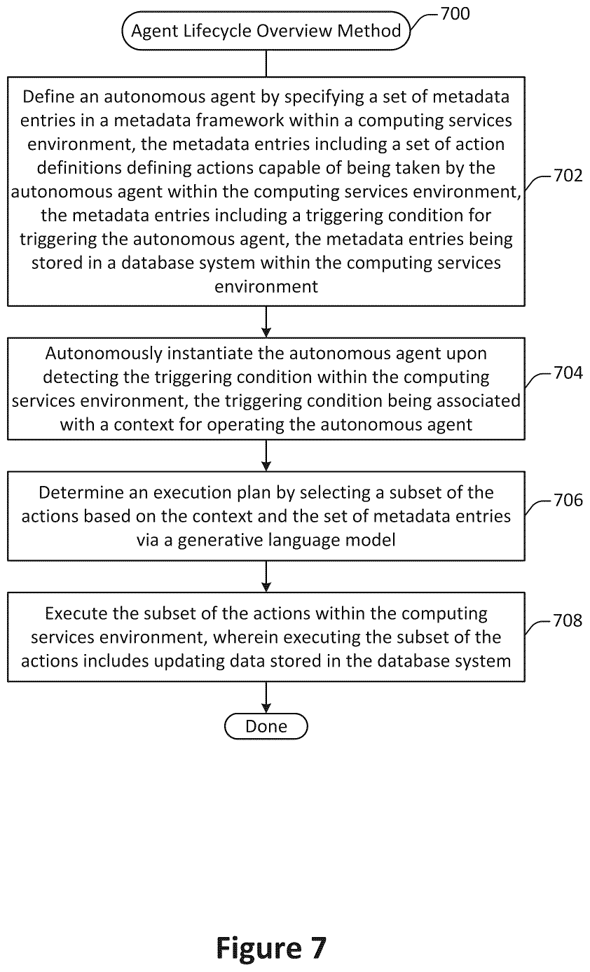

An instance of the autonomous agent is instantiated at 106 based on the autonomous agent definition. In some embodiments, the autonomous agent instance may be instantiated via the agent service 914 shown in FIG. 2. Instantiating the autonomous agent may involve one or more operations related to provisioning the autonomous agent instance, determining an initial context for the autonomous agent instance, and the like. Additional details regarding such instantiation are discussed with respect to the method 700 shown in FIG. 7.

An orchestration plan is determined at 108 based on actions identified in novel planning text generated by a generative language model based on the autonomous agent definition. According to various embodiments, the orchestration plan may be determined by the orchestration layer 626 shown in FIG. 2. The identified actions are executed by the computing services environment 100.

In some implementations, one or more of the actions included in the orchestration plan may be selected from actions included in the autonomous agent definition. Such actions may be identified and/or created as discussed with respect to the operation 104. However, not all actions included in the autonomous agent definition need be performed by any particular autonomous agent instance. Further, actions selected for performance may include actions other than those created via the creation process discussed with respect to the operation 104. For instance, one or more default or standard options available via the computing services environment may be selected for performance

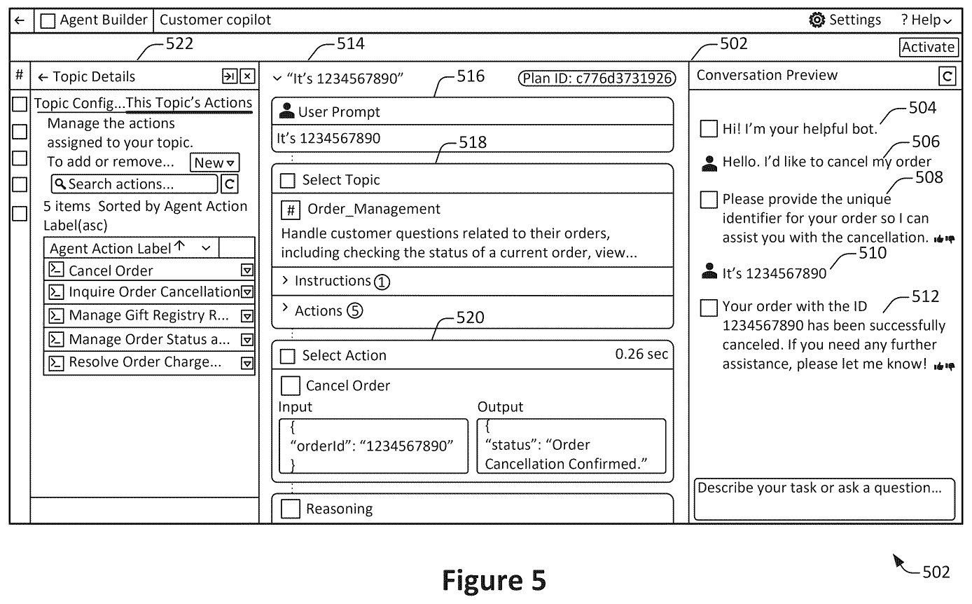

FIG. 5 illustrates a user interface 500 through which a simple interaction with an autonomous agent trained in accordance with techniques and mechanisms described herein is shown. A preview of the conversation is shown at 502. At 504, the autonomous agent states “Hi! I'm your helpful bot.” At 506, the user responds saying “Hello! I'd like to cancel my order.” At 508, the autonomous agent asks the user to provide the user's order identifier. The user provides the order ID at 510, and at 512 the autonomous agent lets the user know that the order has been successfully canceled.

According to various embodiments, the utterances by the autonomous agent that are shown at 502 may be generated based on a sequence of actions performed as shown at 514. For instance, in response to a user prompt at 516 providing the order number, the autonomous agent selects a topic at 518 corresponding to order management and then selects an order cancelation order at 520. Examples of other actions associated with the topic are shown at 522, including inquiring about order cancelation, managing gift registry returns, managing order status and returns, and resolving order charge issues.

### Autonomous Agent Creation From Database Records

FIG. 3 illustrates a method 300 for creating an autonomous agent, performed in accordance with one or more embodiments. The method 300 illustrates various operations discussed with respect to FIG. 1 and FIG. 2.

A request to create an autonomous agent from chat records is received at 302. In some embodiments, the request is received at the computing services environment 600 and may be generated by a systems administrator. For instance, an administrator of an application instance may submit a request to train an autonomous agent for a particular task based on chat records involving human agents performing that task.

In some embodiments, the request to create the autonomous agent may include autonomous agent configuration information. For example, the autonomous agent configuration information may include metadata characterizing a purpose, application, title, and/or description of the autonomous agent. As another example, the autonomous agent configuration information may identify a population of database records corresponding to chat records to be used to train the autonomous agent. As yet another example, the autonomous agent configuration information may identify default or initial resources, such as a default prompt template including one or more default or generic natural language instructions. As still another example, the autonomous agent configuration information may include one or more overarching guidelines that are not susceptible to modification, such as instructions to perform in a manner that is polite and helpful.

In some embodiments, the autonomous agent may be trained for a specific purpose and/or based on a specific subset of chat transcripts, such as those related to order inquiries. In such a situation, the configuration information may identify a topic or description of a purpose associated with the autonomous agent. Such information may be used to select and/or evaluate chat records for training. For instance, a chat record may be retrieved and then evaluated in comparison to the topic. If the chat record reflects an interaction that does not pertain to the topic, the chat record may be disregarded for training purposes.

At 304, an autonomous agent definition is initialized. According to various embodiments, the initial autonomous agent definition may include one or more of various initial or default resources. For instance, a default prompt template for an autonomous agent definition may include one or more generic natural language instructions. Such generic natural language instructions may, for instance, instruct the generative language model to generate text, selection actions, or perform other such operations based on input data that includes information associated with an interaction with an individual. They may also include general or default guidelines, such as prohibitions against hallucination, biased action, biased speech, pejorative language, or other such actions. Once initialized, the autonomous agent may be associated with a definition or state that includes elements such as actions, patterns, instructions, metadata, test cases, and/or other such components.

A chat record training data sample is determined at 306 by selecting it from a population of chat records. In some embodiments, chat records may be selected at random from the population. Alternatively, chat records may be selected based on some kind of ordering mechanism. For example, chat records may be classified on one or more dimensions and then selected using stratified random sampling. As another example, chat records may be ordered, for instance based on factors such as success of the interaction, experience or rating of the human agent, or other such considerations. Then, the better-ranked chat records may be selected first to establish a stronger initial baseline for the autonomous agent.

In some embodiments, a training iteration may be based on a single chat record. The single chat record may include one or more utterances conducted between an individual and a human agent in the context of an interaction. Such utterances need not be conducted in close temporal proximity but do relate to the same interaction. Alternatively, a training iteration may be based on multiple chat records. For instance, a set of chat records related to similar types of interactions, such as those pertaining to canceling an order, may be analyzed in the same training iteration.

In some embodiments, the chat records may be selected from a population without replacement. In such a configuration, a chat record selected for use in training the autonomous agent may be used to train the autonomous agent only once. In other configurations, the chat records may be selected from the population with replacement. In such a configuration, a chat record selected for use in training the autonomous agent may be selected again to train the autonomous agent in a subsequent iteration.

A hypothesized set of actions and/or other elements of the autonomous agent definition are determined at 308 from the chat record training data sample. In some embodiments, such actions and other elements may be determined by analyzing the chat record training data sample via a generative language model. The generative language model may be provided with natural language instructions specifying that the generative language model should analyze the chat records and produce descriptions of the actions and other elements in accordance with natural language instructions and based on the information included in the chat records. The hypothesized set of actions may be those conjectured by the generative language model to, if actually performed, generate a conversation similar or identical to the chat record being analyzed.

In some embodiments, an action, as hypothesized by the generative language model, may include one or more elements. For example, an action may include metadata specifying information such as a name and description of the action. As another example, an action may include one or more natural language instructions to include a prompt that is completed to execute the action. As yet another example, an action may include data retrieval information used to retrieve data from a data source accessible via the computing services environment.

In some embodiments, the determination of a hypothesized set of actions may be divided into a reasoning portion and a hypothesis determination portion. An example of a prompt template that may be used to reason about potential changes to an autonomous agent definition in accordance with one or more embodiments is as follows. In this and the following examples of prompt templates, fillable portions such as “% s” and “% d” may be replaced at runtime with appropriate input so as to determine an input prompt from the prompt template. A generative language model may then generative novel text to complete the input prompt by executing the natural language instructions included in the input prompt.

### #Primary Goals and Context

You are tasked with reviewing previous customer conversations with a bot agent for an e-commerce service, which may sometimes also include interactions with a live agent.
The e-commerce service and agent are associated with the following TENANT INFO, and tenant-specific constraints/guidance: %s
Your primarily goal is to reason through the current batch of chat examples as to what they motivate for any changes to the state.
Later on, we will use this reasoning to output a patch for our existing STATE.

### #What is State

The state object's primary assets are a set of well-chosen actions/functions to be utilized by an llm agent in the chats from the topic.
We want to curate representative “kinds” of chats or beginning user utterances that motivate the various actions, possibly used composably together.
We also want to curate instructions on how an agent is to optimally use these tools, beyond just their schema descriptions.
Similar to a guidebook/cheatsheet for a new operator/agent: “what instructions would be most useful for an agent to use in the moment?”

### #Action Library Guidelines

The actions are intended to be used by an llm agent as “tools” to address any customer's relevant needs in a chat system.
Each action should be designed to be used in this way for _any_ chat, and not designed myopically to several rare and unique examples.
We should attempt to minimize the need to escalate to real human agents, except where necessary.
As such, we should design the actions to be comprehensive as a whole, while also avoiding duplication of functionality or purpose.
The actions should be functions which could operate on a database of the company, or other services it may provide.
The actions will be implemented in salesforce apex and can interacted with the relevant org via SOQL and the like.
The actions should be so atomic so that we end up with a zoo of them.
They should broad enough to encompass most chat circumstances ever encountered, but not grain enough so as to be confusing for the agent to reason about as to which of too many actions is relevant to address the customer's chat input.

### #Context on Downstream LLM Agent Designs

The downstream implementation of the llm agent, which will use these actions/tools, roughly takes the following form:
For every customer message/utterance/user_input/turn, an agent can choose to either (1) output text which gets displayed in the chat to the user, or (2) call a sequence of actions, and then output text, finally ending the turn.
The agent can generate text by calling chat messages against a typical llm api, which supports tool calling style api.
Prior action outputs in a turn sequence can be used as inputs for subsequent ones.
Their arguments can be populated by inferring from chat history context, or asking the user explicitly for clarification if it cannot be determined.

### #Data Quality

Be careful when attending to user utterances in the chat examples, some of them are noisy.
Sometimes the customer input is actually from some user interface that was recorded as if they said it.
We should focus our analysis to attend only to those which are high-quality and actually from humans typing/talking.
Choosing good data to focus on is just as important as analysis and decisions based on that data, for otherwise the analysis is flawed.

### #Tips

This prompt's output is what will be hydrated into the existing state, on subsequent runs of the prompt.
That is, we are attempting to do hill-climbing over the best possible functions for this company's e-commerce service given all of the above guidelines.
Each iteration of the prompt is given a new sample (mini-batch) of chats sampled from the company.
To do this iterative nature, you should be conservative with your updates, and attempt to converge to a solution over time.
Wisely weight what already exists in the state, before updating it with what we learn from just this most recent batch.
Since this prompt's updated state is iteratively fed into its input, you should be cautious of the following convergence problems, and use the stats to orient over time appropriately.

```
# STATISTICS ABOUT CURRENT AND PREVIOUS STATES
HISTORY
%s
# BATCH OF %d REAL CHAT SESSION TRANSCRIPTS
Consider the following real sampled batch of chat sessions:
%s
# EXISTING STATE TO MODIFY
%s
# SCHEMA OF EXISTING STATE
# %s
# FINAL TASK INSTRUCTION
Analyze systematically, and output _reasoning_ in JSON format:
{
  // Data analysis on the BATCH of CHAT TRANSCRIPTS.
  // The point of this analysis is to motivate changes to our existing
state.
  // We must write out that motivation for such changes in this here
analysis.
    // A mindful analysis of observed patterns in this batch of chat
examples.
  “pats”: [{
        // A list of representative snippets briefly demonstrating this
pattern, constrained to the latest batch of examples.
        // Each snippet is a str representing user utterances from a
chat.
      // Snippets should start with user-utterances that began a chat
in earnest, not noisy non-human inputs from some UX or just bad
chat data examples.
      // We should also be careful not to over-index on customers with
unreasonable.
        // Each snippet can cover multiple distinct times in the chat,
concatenated together, from beginning to follow-up, to the end.
                // Snippets should be reaslitic, but need not be
extractive/verbatim.
      // The are intended to provide high-level easily understandable
context on what users are saying and how for this pattern.
      “snips: list[str],
        // A brief, yet lucidly clear, description of what this pattern
represents.
      “desc”: “str”,
        // Whether this observed pattern corresponds to any existing
patterns already, or no if seen for the first time in this batch.
      “type”: “new|exist.same|exist.variant”,
      “how”: <if exist then how, else can be elided/optional>,
      // A unique and short name for this pattern; should be same as
one in state if type==exists.
      // If variant, then the given name here should be a prefix of the
existing pattern name it is a _variant of_.
      // Pattern names are orthogonal to action names; actions can be
applicable to different patterns.
      “name”: “str”,
        // Representative/exemplary chat ids where this pattern was
observed among the batch.
      // Should only focus on most important/high-quality chats, and
not instead all ids seen in the batch.
        // We want this to NOT proportionally scale to the size of the
batch.
        // For example if the batch size is 100 then this should be at
most several at most, and scale logarithmically from there.
      “ids”: [“int”],
      // Possibly useful/relevant existing action names, if any exist.
      “actions”: [“str”],
        // A number rel between 1 and 10 on how important/relevant
this pattern is with respect to the current batch of examples, with 10
be the most important.
      // And if it's 0 then it shouldn't even be mentioned in this list.
      “rel”: “int”,
  }],
  // A reflection on the observed patterns as a whole.
  “reflect”: {
        // Free-form review as to the qualitative nature of the above
patterns.
      “review”: list[“str”],
      // A brief review of how any of the patterns interact with each
other, if any do.
      “interact”: “str”,
          // Problems with respect to how our current state may not
address the observed patterns needs well enough, without changes.
      // We should attempt to be as concrete as possible here, while
still being brief; as such it's ok to use technical short-hand that you
deem naturally useful.
      “problems”: [{
              // Name pattern names from above analysis which are
problematic for this group.
          “pats”: list[“str”],
            // A short code-like name for the reason, as it should have
already have been described in full in the review or interactions
above.
          “why”: “str”,
      }, ...],
  },
}
```

An example of a prompt that may be used to determine hypothetical changes to an autonomous agent definition in accordance with one or more embodiments is as follows:

```
Respond in the following json format:
// Think through how hypothetical changes to our existing state
(modifications, deleting, merging, additions, simplifications,
refactors, etc.) would lead to better or worse behavior in the agent.
// Reducing/refining should always be preferred first, before
increasing complexity via additions.
{
  // A list of criteria that the simulations should keep in mind for this
batch of chat samples, and based on our prior existing
state/patterns.
  // The goal here is to plan out what we intend to break/disprove,
as is the nature of science.
  “crit”: {
      // A set of review criteria to consider when reviewing how this
hypothetical flow worked out.
      // List in the form “what”: “WHY”.
      // Here are some sample what-why criteria from which you can
be inspired, but not limited to:
      “bias”: “str”, // action call chain should not be biased towards
simply playing along with our analysis
      “real”: “str”, // action calls should realistic with respect to the
llm agent setup we've described
      ...
        // The WHY is most important, don't just mantra repeat the
criteria, motivate which ones (ideally new ones naturally for the
situation) are useful for us to recall before proceeding.
      // Choose mindfully and naturally for the situation.
  }
  // A set of different kinds of hypothetical changes, for the purpose
thinking them through to tease apart good ideas from bad.
    // Take care to make sure we consider our prior data analysis
based on this batch of chat examples.
  “hypo”: [
      {
        “abs”: “str”, // a short title/abstract for the hypothesis
        “pats”: [“str”], // list of relevant observed pattern names this
hypothesis pertains to; make sure to reuse pattern names from prior
steps
          “mod”: “str”, // high-level description of what changes this
hypothesis entails
        “curr”: [“str”], // a very brief review of what the current state
of affairs are, so that we may orient to it in our diff
              “diff”: [“str”], // a high-level highly-compressed dense
description of changes in order to test hypothesis
        // A list of simulations to test this hypothesis:
        “sims”: [
            {
              “flow”: {
                  // A succinct high-level description what the user is
trying to achieve.
                “intent”: “str”,
                // What kind of example is this? good|bad|ambiguous|
error|etc?
                “kind”: “str”,
                // A hypothetical list of action calls which would most
likely occur from the above hypothetical changes.
                // The action calls should follow the way the llm agent
has been concretely described previously.
                // They SHOULD NOT self-serve our hypothesis, but
try to evoke problems with it by following supposing the change were
true.
                “actions”: [
                    {
                      “exec”: “str”, // the action called and with what
arguments
                        “res”: “str”, // the expected result in this
hypothetical flow
                    },
                    ...
                ],
                // A probably realistic llm agent response to the user
after performing these call of actions, and seeing them in the chat
history to reference.
                “resp”: “str”,
              },
            },
                ... more hypothetical flows as needed to think things
through effectively
        ],
      },
      ... more hypotheses to address anything new from batch, or not
addressed well enough in state already
  ],
}
```

The identified set of actions, instructions, and other elements, along with the pre-existing state of the autonomous agent being created, is used at 310 to simulate the performance of the autonomous agent in response to the input reflected in the chat transcripts. In some embodiments, the simulation may be performed by a procedural implementation of the agent, such as one implemented in a language such as Python. The simulated may be used to generate hypothesized or simulated output, such as text, that may be generated by the autonomous agent were the autonomous agent definition information updated to include the actions and other updates hypothesized at operation 308.

Simulated autonomous agent definition information that includes the hypothesized set of actions is determined at 312. The simulated autonomous agent definition information may include the existing autonomous agent definition supplemented and/or modified with the hypothesized set of actions and other elements. Determining the simulated autonomous agent definition may involve operations such as reasoning about the simulated autonomous agent output data determined at 310 and determining changes to the autonomous agent definition based on that reasoning via a generative language model.

An example of a prompt template that may be used to reason about the simulated autonomous agent output data in accordance with one or more embodiments is as follows:
The following was observed after running the simulated results: %s
Now given these results reason through what happened, in the following JSON form:

```
{
  “obs”: [
    {
        “ids”: list[int], // which ids of testcases this observation is
attending to
      “pat”: list[“str”], // very concise snips observed
      “expect_actions”: list[“str”], // what was concretely expected
to have had happen for action/tool calls and their args?
      “expect_other”: list[“str”], // any other expectations
      “res”: list[“str”], // did the expectation occur or not? and how
did it differ?
        “why”: list[“str”], // what are some likely causes? actions,
instructions, etc.
    },
    ... // continue through all observations
  ],
  “reflect”: {
    “bad”: list[str],
    “good”: list[str],
    “neutral”: list[str],
    “implications”: list[str],
  }
```

An example of a prompt template that may be used to determine the simulated autonomous agent definition information based on the reasoning about the simulated output data in accordance with one or more embodiments is as follows:

```
Now, given all the above reasoning, simulations, let's draft up what
we will want to therefore change in our existing STATE, if anything.
Please be mindful of any constraints listed in the TENANT INFO from
earlier in the discussion. Respond in the following JSON format:
{
  // A sentence to best orient yourself toward performing this “draft”
task well, given all the wisdom from above.
    “orient”: “str”,
    “review”: {
    // A list of criteria or principles that are relevant to keep in mind
when drafting our modifications.
            // Which parts of TIPS, DATA QUALITY, or other
CONTEXT/GUIDELINES from earlier discussion about our GOALS
are MOST important to attend to.
      // <part or aspect>: list[<criterion snippet1>, <data quality
insight2>, <relevant tip recall3>, <context insight4>],
      “criteria”: dict[str, list[str]],
      // A list of any constraints to be mindful of, only as relevant to
drafting modifications to the STATE.
      “constraints”: list[“str”],
      // Notes about the STATISTICS / STATE HISTORY from earlier
discussion as it relates to the guidance about our modifications.
      “stats”: list[str],
          // Take a moment of pause to reflect on how best to
incorporating new observations into old state.
      // What existing things about the current state should we keep
in mind with respect to new things we are seeing?
      // Which actions/instructions/patterns are pre-existing, or new,
or are under consideration for
modification/merge/remove/add/simplify/etc?
      “exist”: list[str],
    // List of top-level fields in state we should attent to / remember
to edit for this update.
      “fields”: list[str],
        // A list of high-level descriptions of interactions between
patterns we've seen from previous analysis, or simulation, or other
discussion.
      // These interactions should be noted now so that we may not
greedily or myopically focus on just one aspect, while ignoring these
relevant interactions.
      “inter”: list[str],
      // Anything else that you deem worthwhile to review given this
current batch of examples, and where we are in the batch training
history.
      “other”: list[str],
    }
    “therefore”: {
      “reflect”: dict[str, Any],
    // Very high-level descriptions as to what changes seem good or
bad after all of the above review.
      “plan”: [
        {
              // A brief description as to why we are making these
changes, what is motivating them.
            // This should briefly refer to what in previous discussion
this is coming from.
                // It doesn't need to retell it, but merely reference
keywords / keyphrases / snippets from prior so as to ATTEND to the
most relevant motivating parts.
          “why”: “str”,
          // A high-level description of what should be changed, and
roughly how.
          // This is a draft, so the details don't need to be perfect or
complete.
          “desc”: list[“str”],
                // A calibrated confidence score between 0 and 10
indicating how important/confidence we are in this specific
modification draft.
              // 10 indicates utter clarity given all the context and
reasoning as laid out, while 0 indicaes significant uncertainty and
contradictions to motivation.
          “conf”: < int>,
        },
          ... // continue through all high-level points which should be
reviewed before committing to concrete changes
      ]
    },
}
```

A determination is made at 314 as to whether a patch to the autonomous agent definition is indicated. In some embodiments, the determination may be made at least in part by comparing the simulated autonomous agent definition information determined at 310 with the pre-existing autonomous agent definition information. If the simulated autonomous agent definition information differs significantly from the existing autonomous agent definition information, then a patch may be indicated. If instead the simulated autonomous agent definition information is substantially included within the existing autonomous agent definition, then potentially a patch need not be generated.

A patch to the autonomous agent definition is determined at 316 based on the hypothesized set of actions and other elements, the simulated autonomous agent definition and simulated outcomes, and the existing autonomous agent definition. The patch may include any information needed to update the pre-existing autonomous agent definition to reflect the hypothesized set of actions determined at 308. Additional details for determining such a patch are discussed with respect to the method 400 shown in FIG. 4.

Upon determining the patch, the agent definition and associated tools and test cases are updated at 318 based on the patch. In some embodiments, the agent definition may be used by setting the current agent definition to the pre-existing agent definition upon applying the patch, as discussed with respect to FIG. 4. Additionally, one or more elements employed by the agent, such as procedural code associated with one or more actions performed by the agent, may also be updated.

An example of a prompt template used to update procedural source code employed by the autonomous agent in accordance with one or more embodiments is as follows. The following example is directed to the generation of procedural code implemented in the Apex language available from Salesforce, Inc. However, a similar approach may be used to generate procedural code implemented in other languages.

```
# PRIMARY GOAL
Given a STATE object:
- Implement an Apex class for the TENANT's Salesforce Org that
fulfills target
  action.
- Apex class implementation should correct and error-free Apex
implementation.
- Follow the function signature for the target action as noted in the
STATE.
- Implement the Apex class with mock responses to certain kinds of
inputs based
  on the relevant example/pattern also noted in the STATE.
# STATE STRUCTURE
The STATE object provides the following key components:
- Actions: Lists all defined actions, each with:
  - name: The name of the action.
  - description: The action's purpose and context.
  - inputs: A list of input variables (name, description), some of which
are
    required.
  - outputs: A list of output variables (name, description).
- Patterns: Represents conversational scenarios with:
  - examples: User instructions, sample inputs, expected outputs, and
response patterns.
```

### #APEX Developer Guide

### ##Classes

As in Java, you can create classes in Apex. A class is a template or blueprint from which objects are created. An object is an instance of a class. For example, the PurchaseOrder class describes an entire purchase order, and everything that you can do with a purchase order. An instance of the PurchaseOrder class is a specific purchase order that you send or receive.
All objects have state and behavior, that is, things that an object knows about itself, and things that an object can do. The state of a PurchaseOrder object—what it knows—includes the user who sent it, the date and time it was created, and whether it was flagged as important. The behavior of a PurchaseOrder object—what it can do—includes checking inventory, shipping a product, or notifying a customer.
A class can contain variables and methods. Variables are used to specify the state of an object, such as the object's Name or Type. Since these variables are associated with a class and are members of it, they are commonly referred to as member variables. Methods are used to control behavior, such as getOtherQuotes or copyLineItems.
A class can contain other classes, exception types, and initialization code.
An interface is like a class in which none of the methods have been implemented—the method signatures are there, but the body of each method is empty. To use an interface, another class must implement it by providing a body for all of the methods contained in the interface.

### ##Apex Class Definition

### Apex Class Definition

In Apex, you can define top-level classes (also called outer classes) as well as inner classes, that is, a class defined within another class. You can only have inner classes one level deep. For example:

```
‘‘‘
public class myOuterClass {
  // Additional myOuterClass code here
  class myInnerClass {
    // myInnerClass code here
  }
}
‘‘‘
```

To define a class, specify the following:
1. Access modifiers:
   You must use one of the access modifiers (such as public or global) in the declaration of a top-level class.
   You don't have to use an access modifier in the declaration of an inner class.
2. Optional definition modifiers (such as virtual, abstract, and so on)
3. Required: The keyword class followed by the name of the class
4. Optional extensions or implementations or both

### Note

Avoid using standard object names for class names. Doing so causes unexpected results.

Use the following syntax for defining classes:

‘‘‘
private | public | global
[virtual | abstract | with sharing | without sharing]
class ClassName [implements InterfaceNameList] [extends
ClassName]
{
// The body of the class
}
‘‘‘

The ‘private’ access modifier declares that this class is only known locally,
   that is, only by this section of code. This is the default access for inner classes—that is, if you don't specify an access modifier for an inner class, it's considered ‘private’. This keyword can only be used with inner classes (or with top-level test classes marked with the ‘@IsTest’ annotation).
The ‘public’ access modifier declares that this class is visible in your application or namespace.
The ‘global’ access modifier declares that this class is known by all Apex
   code everywhere. All classes containing methods defined with the ‘webservice’ keyword must be declared as ‘global’. If a method or inner class is declared as ‘global’, the outer, top-level class must also be defined as ‘global’.
The ‘with sharing’ and ‘without sharing’ keywords specify the sharing mode for this class.
The ‘virtual’ definition modifier declares that this class allows extension
   and overrides. You can't ‘override’ a method with the override keyword unless the class has been defined as ‘virtual’.
The ‘abstract’ definition modifier declares that this class contains abstract methods, that is, methods that only have their signature declared and no body defined.

### Note

You can't add an abstract method to a global class after the class has been uploaded in a Managed-Released package version.
If the class in the Managed-Released package is virtual, the method that you can add to it must also be virtual and must have an implementation.
You can't override a public or protected virtual method of a global class of an installed managed package.

A class can implement multiple interfaces, but only extend one existing class. This restriction means that Apex doesn't support multiple inheritance. The interface names in the list are separated by commas.

### ###Versioned Behavior Changes

In API version 61.0 and later, private methods are no longer overridden by an instance method with the same signature in a subclass. This change is versioned, so to prevent the override, update your abstract or virtual classes that contain private methods to API version 61.0 or later. In API version 60.0 and earlier, if a subclass declares an instance method with the same signature as a private method in one of its superclasses, the subclass method overrides the private method.

### #EXAMPLES

Here is a sample Apex implementation of a promotion lookup service:

```
global with sharing class PromotionLookupService {
  global with sharing class PromotionLookupRequest{
        @InvocableVariable(required= false description=‘search
terms’)
    public String promoSearchKeywords;
  }
  global with sharing class PromotionInfo{
    @InvocableVariable(required= true description=‘promo id’)
    public String promoId;
    @InvocableVariable(required= true description=‘name for this
promotion’)
    public String promoName;
    @InvocableVariable(required= false description=‘promo code’)
    public String promoCode;
        @InvocableVariable(required= false description=‘promo
description’)
    public String description;
        @InvocableVariable(required= true description=‘promo
status’)
    public Boolean isActive;
  }
  @InvocableMethod(label=‘lookup_promo’ description=‘Returns a
list of promo records for the given search terms')
          global static List<List<PromotionInfo>>
getpromos(List<PromotionLookupRequest> lookupRequests) {
            List<List<PromotionInfo>> results = new
List<List<PromotionInfo>>( );
    for(PromotionLookupRequest activeRequest : lookupRequests)
    {
      // Replace SOQL with dummy data for testing
      if (activeRequest.promoSearchKeywords == ‘P123’) {
```

results.add(new

```
PromotionInfo(promoId=‘001’,promoName=‘Summer Sale’,
isActive=True));
      }
      if (activeRequest.promoSearchKeywords == ‘P234’) {
```

results.add(new

```
PromotionInfo(promoId=‘002’,promoName=‘Clearance Sale’,
isActive=False));
      }
    }
    return results;
  }
}
```

This example is for reference only. Follow the general guidelines provided above when writing your own Apex code.

### #Final Task Guidelines

Function Signature Implementation: Implement the provided function signature in Apex.
Dummy Data Generation: Replace any SOQL statements with code that responds to dummy data. List the input to which the code will respond at the end of generated code, as exemplars.
Sample Utterances: Adjust the output based on provided sample conversations or additional details in the function signature. If no examples are provided, generate dummy data.
Output Testing: Ensure that the Apex code includes expected input and output values.
Note: In the latest version of Apex, the @InvocableVariable annotation does not use a comma between different arguments. For example, use (required=true description=‘promo id’) instead of (required=true, description=‘promo id’). Do not add a comma between the required and description arguments.
Be careful to escape possessive's inside arguments which are themselves quoted, such as with @InvocableMethod(description=‘This string contains a single quote: it\'s escaped.’).

In some embodiments, updating the agent definition and associated tools and test cases at 318 may also involve reflecting on the changes that have been implemented. Such reflection may then be used to guide subsequent training iterations. Alternatively, or additionally, such reflection may also be used to help determine whether additional training is needed. An example of a prompt template that may be used to reflect on the changes implemented by the proposed patch in accordance with one or more embodiments is as follows.
You possess deep knowledge of proven prompting techniques and wisdom. Your primary task is analyze the given prompt step-by-step. You recognize and point out common prompt problems/patterns. You prefer to focus on specific concrete parts in the prompt that may have led to problems in the generated output. You use concrete evidence in the prompts and recall specific principles to motivate your suggestions. You prefer to abstractly reason like “because of this part in the prompt ... and this inferred intended goal ... and so this seemingly bad output ... this part of the prompt ... should be concretely changed into x”.

```
“““,
  },
  {
    “role”: “user”,
    “content”: ”””
```

### #Task

Apply your knowledge to analyze prompt messages and their outputs according.

We wish to determine if the OUTPUT is “good” given the PROMPT, without ground truth. The chat examples are unmodifiable real data for which we orient ourselves, but do not consider for modification. All the other chat messages were prompt constructed.

DO NOT SUGGEST ANY CUSTOMER/TENANT BESPOKE changes, they MUST BE GENERIC.

# PROMPT
Consider the following primary unhydrated PROMPT llm chat
messages, which in a sense form a function implementation which
takes unhydrated strings as args:
<PROMPT>
%s
</PROMPT>
# MESSAGES
After hydrating that prompt, and combining it with this history it
ended up with this list of chat messages:
<MESSAGES>
%s
</MESSAGES>
# OUTPUT
Then finally those hydrated MESSAGES resulted in the following
OUTPUT message (given the chat messages whose last parts are
from the PROMPT):
<OUTPUT>
%s
</OUTPUT>

Reason through in the following JSON format:

```
{
  “scratchspace”: “str”, // freeform text to allow yourself to orient
yourself to the task
  // A list of observations / data analysis on the INPUT that led to
OUTPUT.
  // Don't observe the unmodifiable chat examples.
  // Instead focus on things/tasks/goals that the prompt (list of chat
messages) seems to be trying to achieve, and may or may not be
doing for various reasons as evidenced by the OUTPUT.
  // Consider whether there are problems with respect to any of but
not limited to: prompt structure, ambiguity, misinterpretations,
aleatoric/epistemic uncertainty, problem with prompt, lack of best
practices, etc.
  “obs”: [
    {
        // Concrete anchor / text-snippets to a part of the PROMPT,
MESSAGES, or OUTPUT that this observeration is in reference to.
        // These SHOULD NOT BE ABSTRACT. These MUST BE
CONCRETE.
      // We state these first, before our reasoning x, so as to build
up to the more complex nuanced prompt debugging and insights,
rather than jumping straight into it.
      “out”: list[“str”],
      “in_msg”: list[“str”],
      “in_prompt”: list[“str”],
      // Given these concrete details for i/o, both hydrated (in_msg,
out) and uyndrated (out), what is this observation about?
      // What problem(s) are occurring?
      “x”: list[“str”],
    },
    ... // as many as needed
  ],
  // A review / final integration of the observations from above.
  // These should not simply by a retelling of observations.
    // These should be high-level patterns/principles which are seen
after laying everything out.
  // What really matters, and what doesn't?
  // Let's prefer fixing problems over reinforcing things that already
work.
  “review_obs”: [
    {
        // A description of the high-level pattern seen across the
observations.
      “pat”: “str”,
      // An arbitrary score on how important we think this pattern
is with respect to all observations seen.
      // Between 1 and 10 where 10 is higher.
      “score”: <int>,
    },
    ... // as many as needed
  ]
    // Suggestions that are concrete and actionable, based on the
above analysis.
  “suggestions”: list[{
    “part”: “str”, // which part of the prompt are we trying to change
    // A motivation for the modification we are about to say.
    // It should be GROUNDED in our observations and review from
above.
    // We should prefer to be motivated by concrete observations.
    “motivation”: list[“str”],
    // An actionable description of what to change in the prompt.
      // It should be easy to modify the unhydrated PROMPT given
what is written here.
    “mod”: list[“str”],
  }, ...],
}
```

A determination is made at 320 as to whether to continue to train the autonomous agent. In some embodiments, the determination may be made based on the availability of additional training data. Alternatively, or additionally, the autonomous agent may continue to be trained until successive training yields few or no changes to the autonomous agent definition. As still another possibility, the autonomous agent may be trained for a designated number of iterations.

FIG. 4 illustrates a method 400 of creating an autonomous agent patch, performed in accordance with one or more embodiments. A request to determine an agent patch based on a set of proposed changes and simulated output information is received at 402. In some embodiments, the request may be generated as discussed with respect to the operation 316 shown in FIG. 3.

A proposed patch to the existing state is determined at 404. In some embodiments, the proposed patch may be determined based on novel text generated by the generative language model to complete a patch generation input prompt. The patch generation input prompt may include some or all of the information generated based on the chat record, such as the one or more actions, the updated autonomous agent definition information, the simulated autonomous agent output data, and/or any other such information.

In some embodiments, the generative language model may be provided with instructions to generate the proposed patch. The instructions may specify patch formatting information, patch content information, and the like. The patch may include, for instance, one or more semantic groups of actions, state updates, and/or other updated versions of information included in the autonomous agent definition.

In some embodiments, the patch may be implemented in a manner consistent with the autonomous agent definition. For example, in the case of a JSON-based autonomous agent definition, the patch may be implemented in accordance with the JSON PATCH RFC 6902. In such a configuration, the patch generation input prompt may include instructions specifying elements such as JSON tags and properties that may be included within the autonomous agent definition.

An example of a prompt template used to determine a proposed patch in accordance with one or more embodiments is as follows:
Now, using the prior discussion, generate a set of changes to be applied to the current STATE:
%s
Use RFC 6902 JSON Patch operations for all state modifications. When the patches are applied to the STATE, it must remain valid for it's existing schema, as a “second-order constrained generation” to outputting in the StateUpdate schema:
%s

```
<JSON_PATCH_CHEATSHEET>
# # # JSON Patch Reference (RFC 6902)
Use this reference to craft **valid and schema-compliant** JSON
Patch operations. Patches must maintain the validity of the STATE's
schema, ensuring minimal yet comprehensive changes in alignment
with second-order constrained generation principles.
---
# # # # **1. Operation Types**
- **add**:
  - Adds a value to the specified location.
  - Use the ‘-‘ index to append to arrays.
  - **Preconditions**
    - Parent path must exist (e.g., ‘/foo/bar‘ requires ‘/foo‘ to exist).
      - Added value must conform to schema rules (e.g., data type,
constraints).
  - **Example**: { ″op″: ″add″, ″path″: ″/foo″, ″value″: ″bar″ }
- **remove**:
  - Deletes the value at the specified location.
  - **Preconditions**:
    - Path must exist.
        - Ensure removing the field does not violate schema (e.g.,
removing required fields).
  - **Example**: { ″op″: ″remove″, ″path″: ″/array/1″ }
- *replace**:
  - Replaces the value at the specified location.
  - Equivalent to ‘remove‘ followed by ‘add‘.
  - *Preconditions*:
    - Path must exist.
    - Replacement value must conform to schema rules.
  - *Example*: { ″op″: ″replace″, ″path″: ″/baz″, ″value″: ″new_value″
}
- *move*:
  - Moves a value from one location (‘from‘) to another (‘path‘).
  - Equivalent to ‘remove‘ at ‘from‘ followed by ‘add‘ at ‘path‘.
  - *Preconditions*:
    - ‘from‘ must exist.
    - ‘path‘ must not create a circular reference (e.g., moving ‘/foo‘
to ‘/foo/bar‘).
      - *Example*: { ″op″: ″move″, ″from″: ″/source″, ″path″:
″/destination″ }
- *copy*:
  - Copies a value from one location (‘from‘) to another (‘path‘).
  - *Preconditions*:
    - ‘from‘ must exist.
    - Copied value must conform to schema rules at the ‘path‘.
  - *Example*: { ″op″: ″copy″, ″from″: ″/foo″, ″path″: ″/bar″ }
- *test*:
    - Verifies that the value at the specified location matches the
provided value.
  - *Preconditions*:
    - Path must exist.
    - Value comparison must match in type and content.
  - *Example*: { ″op″: ″test″, ″path″: ″/foo″, ″value″: ″bar″ }
---
# # # # **2. Special Syntax**
- **Appending to Arrays**:
  - Use the ‘-‘ index to append items to arrays:
    { ″op″: ″add″, ″path″: ″/array/-″, ″value″: ″new_item″ }
- **Escaping Special Characters in Paths**:
  - Escape ‘/‘ as ‘~1‘ and ‘~‘ as ‘~0‘.
  - Example:
    - Path ‘/key/with/slash‘ becomes ‘″/key~1with~1slash″‘.
---
# # # # **3. Guidelines for Valid Patches**
- **Schema Awareness**:
  - Validate every patch against the STATE's schema.
  - Do not remove required fields or add invalid types.
  - Ensure nested objects and arrays remain structurally valid.
- **Logical Operation Order**:
  - Apply operations in sequence to avoid conflicts:
    - Remove before adding or replacing at the same path.
    - Create parent paths before modifying children.
- **Path Validation**:
    - Verify all paths (‘path‘ and ‘from‘) exist before applying
operations.
    - Avoid appending to non-array fields or modifying nonexistent
parents.
```

```
---
# # # # **4. Examples and Edge Cases**
- **Nested Object Addition**:
  - Add a nested object while ensuring schema validity:
      { ″op″: ″add″, ″path″: ″/parent/child″, ″value″: { ″grandchild″:
{ } } }
- **Complex Array Appends**:
  - Append primitive or complex items to an array:
    { ″op″: ″add″, ″path″: ″/array/-″, ″value″: ″new_item″ }
        { ″op″: ″add″, ″path″: ″/array/-″, ″value″: { ″id″: 1, ″name″:
″item″ } }
- **Numeric Object Keys**:
  - Handle numeric keys in objects vs. arrays:
    - For ‘{ ″0″: ″value″ }‘, ‘/0‘ refers to the object key, not an array
index.
- **Escaped Paths**:
  - Replace a key with special characters:
    { ″op″: ″replace″, ″path″: ″/key~1with~1slash″, ″value″: ″updated″
}
---
# # # # **5. Error Mitigation**
- **Nonexistent Paths**:
  - Example Error:
    *″Path ‘/foo/bar‘ does not exist for ‘add‘ operation.″*
  - Solution: Ensure parent paths exist before adding new fields.
- **Schema Violations**:
  - Example Error:
    *″Value added to ‘/baz‘ is invalid due to type mismatch.″*
  - Solution: Check that added or replaced values conform to schema.
- **Conflicting Operations**:
  - Example error:
    *″Cannot apply ‘remove‘ and ‘add‘ to ‘/foo‘ in the same patch.″*
  - Solution: Reorder operations to avoid conflicts.
</JSON_PATCH_CHEATSHEET>
```

### Guidelines

You must take care to ensure that the STATE's schema is still valid, after
   your proposed patches would be applied, e.g. don't miss any required fields, etc.
Attempt to keep your patches minimal with respect to your goal changes.
Ensure we update all the fields of the state that we_want_to, not just myopically focusing one part of the state to modify.
Follow the already thought-through wise reasoning from prior in the chat, do not muse new ideas here for the first time.

Now, please reason and then output changes in the following JSON format, and keep both the guidelines and patch reference in mind as you generate:

```
{
    // A list of high-level groups to organize our thoughts before
writing in patch syntax.
      // We do this to synthesize all of the prior discussion into
sensible, non-conflicting, motivated changes to the state.
  // For otherwise, we might greedily write patch changes which
conflict, or are sub-optimal in someway.
  // So, take a breath, and mindfully collect yourself.
  “groups”: [
      {
          // Which aspect(s)/area(s)/theme(s) of the state this group
is about, for which we will attend to with this group.
          “aspect”: “str”,
        // A short abstract / subject title for what this change group
is.
          “abs”: “str”,
            // Clear and motivated evidence for WHY this group of
changes is wanted, synthesizing from all our prior reasoning.
              // It should include very concise descriptions of the
quintessential aspects that clearly corroborate us doing this abs.
          “why”: list[“str”],
          // Briefly, at a abstract/high-level, WHAT is to be changed,
merged, simplified, tweaked, deleted, etc.
          // The goal here is to prepare and organize our thoughts,
before we subsequently write in RFC 6902 syntax.
          “what”: list[“str”],
      },
          // As many as are needed given our prior reasoning and
simulations.
      ...
  ],
  “patches” [
      // Standard RFC 6902 JSON Patch operations
      ...
  ]
}
```

An attempt is made at 406 to apply the patch to the existing agent state. The attempt may involve determining whether the patch constitutes valid markup in accordance with the formatting requirements for the autonomous agent definition.

A determination is made at 408 as to whether the patch succeeded. The patch may succeed if the patch is formatted in accordance with the autonomous agent definition requirements imposed by the computing services environment. For instance, the unified metadata framework may specify particular structures in the form of tags and attributes that make up a valid autonomous agent definition. The attempt to apply the patch may succeed only if the patch is valid based on those requirements.

Upon determining that the patch succeeded, the patch is evaluated at 410 based on the proposed set of changes and simulated output information. In some embodiments, the patch may be evaluated by the generative language model. For instance, the generative language model may be instructed to generate novel text indicating the extent to which the proposed patch reflects the proposed set of changes and the simulated output information. Evaluating the patch may involve operations such as aligning the patch with the simulated output data, checking the reasoning reflected in the patch, and evaluating the patch's structure. Based on such validation, additional patching may be performed before the next sample of chat transcripts is used to further update the autonomous agent definition.

An example prompt template that may be used to facilitate evaluation of the proposed patch in accordance with one or more embodiments is as follows:
Does the current latest state look correct and complete given our previous reasoning and other discussion? Please respond and reason in the following JSON manner as to whether we are satisfied with state as is according to criteria or not:

```
{
  “crit”: { // criteria
    “missing”: {
        “prior_reasoning”: list[str], // any missing reasoning from
prior in the chat that we forgot to apply
      “state_fields”: list[str], // any missing top-level state fields we
forgot to attend to
    },
    “incorrect”: {
          “reasoning”: list[str], // any reasoning that we applied
incorrectly, or misconstrued
          “fields”: list[str], // any change applications which look
incorrect
    },
    “other”: {
        “<sub_crit_name>“: list[“arbitrary as motivated by meta,
instructions, things about this batch, etc.”],
      “<other_sub_crit_name>: list[“str”],
    },
  }
  // Whether to do another patch round:
  “should_do_another_patch”: {
    “reasoning”: “str”, // freeform reasoning
    “weight”: “str”, // a weight to our reasoning, i.e. how strong we
feel
      “should_do”: <bool>, // whether given our reasoning, and its
weight, we should in fact do another round of patching to the state
  }
}
```

A determination is made at 412 as to whether to determine an updated proposed patch. According to various embodiments, various considerations may affect whether to determine an updated proposed patch. For instance, a maximum number of proposed patches may be determined before the training iteration is treated as failed and then disregarded.

In some embodiments, the application of the patch may fail at 406 due to malformed JSON produced by the generative language model. An updated proposed patch may be determined upon determining at 408 that the patch attempt did not succeed.

In some embodiments, the patch may not fully reflect the set of actions, instructions, and other elements identified by the creation process. An updated proposed patch may be determined upon determining at 410 that the patch, though valid, insufficiently reflected the changes to the autonomous agent definition indicated based on the hypothesized set of actions determined at 308.

Upon determining to determine an updated proposed patch, patch feedback information is identified at 414. According to various embodiments, the patch feedback information may include information such as one or more previous proposed patches, one or more errors produced when attempting to apply the proposed patched, evaluation information determined at 410, and/or any other relevant information.

An example of a prompt that may be used in the course of determining an updated proposed patch in accordance with one or more embodiments is as follows:
Ok given that validation, let's do another round of patching, building off of our most recent state from the last patch application.
Only suggest changes according to our above validation criteria.
Please generate a patch in the same output style as before with high-level groups, and then specific json patches to apply from those groups.

Upon determining instead not to determine an updated proposed patch, a determination is made at 414 as to whether to update the autonomous agent based on the proposed patch. In some embodiments, the determination may be made based on whether attempt to apply the patch succeeded at 408 and whether the proposed patch sufficiently reflected the proposed set of changes and simulated output information at 410.

Upon determining to update the autonomous agent definition information based on the proposed patch, the autonomous agent definition information is updated at 416. Updating the autonomous agent definition information may involve updating the current state of the autonomous agent definition information to be that determined by applying the proposed patch to the previous state of the autonomous agent definition information.

In some embodiments, updating the autonomous agent definition information may involve determining one or more examples of actions, test cases, patterns, utterances, instructions about how to use the actions, and/or other elements of autonomous agent training. Such information may be used in subsequent training iterations. For instance, such information may be used to evaluate subsequent hypothesized changes to the autonomous agent definition, to evaluate subsequently proposed patches, and/or perform other such training operations.

### Autonomous Agent Definition Information

The following text portions illustrate an example of data processed and generated in accordance with one or more embodiments. For example, the immediately following text portion illustrates an analysis of chat records by an LLM, including elements such as actions to be performed (e.g., OrderCancellationRequest) to respond to user input.

```
{
  “pats”: [
    {
      “snips”: [
          “I ordered a product and it was supposed to be delivered
by a certain date, but it keeps getting delayed. Can you provide an
update?”,
        “The delivery date has been pushed back 4 times now. Can
you tell me when I can expect to receive this order?”
      ],
          “desc”: “Customers inquiring about delayed orders and
seeking updates on the expected delivery date.”,
      “type”: “exist.same”,
      “how”: “Matches the existing OrderDelayInquiry pattern.”,
      “name”: “OrderDelayInquiry”,
      “ids”: [81, 142],
      “actions”: [“TrackOrderStatus”],
      “rel”: 8
    },
    {
      “snips”: [
            “I received a product, but it was damaged. Can I get a
replacement?”,
            “The item I received was damaged. How do I go about
getting a replacement or refund?”
      ],
            “desc”: “Customers reporting damaged products and
requesting replacements or refunds.”,
      “type”: “exist.same”,
            “how”: “Matches the existing ProductDamageReport
pattern.”,
      “name”: “ProductDamageReport”,
      “ids”: [128, 197],
      “actions”: [“ReportAndReturn”],
      “rel”: 7
    },
    {
      “snips”: [
          “I'd like to cancel the item in order 342462081338 that
hasn't shipped yet.”,
        “I want to cancel an order. Can you help me with that?”
      ],
      “desc”: “Customers requesting to cancel orders that have not
yet shipped.”,
      “type”: “exist.same”,
          “how”: “Matches the existing OrderCancellationRequest
pattern.”,
      “name”: “OrderCancellationRequest”,
      “ids”: [167, 178],
      “actions”: [“OrderModification”],
      “rel”: 6
    },
    {
      “snips”: [
          “I need to return an item for an online order received in
the incorrect color.”,
          “I want to initiate a return for a product I received that
was not as expected.”
      ],
      “desc”: “Customers initiating the return process for products
received with issues.”,
      “type”: “exist.same”,
            “how”: “Matches the existing ReturnProcessInitiation
pattern.”,
      “name”: “ReturnProcessInitiation”,
      “ids”: [106, 197],
      “actions”: [“ReturnInitiation”],
      “rel”: 5
    },
    {
      “snips”: [
          “I have a question about a product. Can you provide more
details?”,
          “I'm intersted in a product but need more information
before purchasing.”
```

```
      ],
          “desc”: “Customers seeking detailed information about
products before making a purchase.”,
      “type”: “new”,
      “name”: “ProductInformationInquiry”,
      “ids”: [165, 183],
      “actions”: [“ProvideProductDetails”],
      “rel”: 7
    }
  ],
  “reflect”: {
    “review”: [
      “The patterns observed in this batch align well with existing
patterns, indicating a consistent set of customer inquiries.”,
      “There is a recurring need for detailed product information,
suggesting a potential gap in the current action set.”,
        “Order-related inquiries, such as delays and cancellations,
remain prevalent and are well-supported by existing actions.”
    ],
      “interact”: “The patterns for order delays and cancellations
often interact, as customers experiencing delays may subsequently
request cancellations.”,
    “problems”: [
      {
          “pats”: [“ProductInformationInquiry”],
          “why”: “missing_action”
      }
    ]
  }
}
```

As another example, the immediately following text portion illustrates the generation of hypothetical changes to an agent definition by an LLM based on analysis of one or more chat records.

```
{
  “crit”: {
      “bias”: “The action call chain should not be biased towards
simply confirming our analysis, but should instead challenge our
assumptions.”,
      “real”: “Action calls should be realistic with respect to the
described llm agent setup, ensuring they align with how an agent
would naturally operate.”
  },
  “hypo”: [
    {
            “abs”: “Introduce a new action for detailed product
information inquiries”,
      “pats”: [“ProductInformationInquiry”],
          “mod”: “Add a new action to handle detailed product
information requests.”,
        “curr”: [“Currently, there is no specific action for handling
detailed product information inquiries.”],
        “diff”: [“Add a ProvideProductDetails action to address the
gap in handling detailed product inquiries.”],
      “sims”: [
        {
          “flow”: {
            “intent”: “The user wants detailed information about
a specific product before making a purchase.”,
            “kind”: “good”,
            “actions”: [
              {
```

“exec”:

```
“ProvideProductDetails(product_id=‘SKU123456’)”,
                “res”: “Detailed product information including
dimensions, materials, and care instructions.”
              }
            ],
                “resp”: “Here are the details for the product you
inquired about: [Product details]. Let me know if you have any other
questions!”
          }
        },
        {
          “flow”: {
                “intent”: “The user is unsure about the product's
features and needs clarification.”,
            “kind”: “ambiguous”,
            “actions”: [
              {
```

“exec”:

```
“ProvideProductDetails(product_id=‘SKU789012’)”,
                “res”: “Detailed product information including
features and specifications.”
              }
            ],
                “resp”: “I've provided the product details you
requested. If you need further clarification, feel free to ask!”
          }
        }
      ]
    },
    {
      “abs”: “Refine existing actions to better handle order-related
inquiries”,
      “pats”: [“OrderDelayInquiry”, “OrderCancellationRequest”],
      “mod”: “Refine existing actions to improve handling of order
delays and cancellations.”,
            “curr”: [“Current actions handle order delays and
cancellations but may not be fully optimized for all scenarios.”],
        “diff”: [“Enhance TrackOrderStatus and OrderModification
actions to provide more comprehensive support for delays and
cancellations.”]
```

```
      “sims”: [
        {
          “flow”: {
              “intent”: “The user wants to cancel an order due to
repeated delays.”,
            “kind”: “good”,
            “actions”: [
              {
```

“exec”:

```
“TrackOrderStatus(order_id=‘342462081338’)”,
                “res”: “Order is delayed, estimated delivery in 2
weeks.”
              },
              {
```

“exec”:

```
“OrderModification(order_id=‘342462081338’,
modification_type=‘cancel’)”,
                “res”: “Order cancellation confirmed.”
              }
            ],
                “resp”: “Your order has been delayed, and I've
successfully canceled it as per your request. You will receive a
confirmation email shortly.”
          }
        },
        {
          “flow”: {
            “intent”: “The user is frustrated with repeated delays
and wants to explore cancellation options.”,
            “kind”: “ambiguous”,
            “actions”: [
              {
```

“exec”:

```
“TrackOrderStatus(order_id=‘342293853491’)”,
                “res”: “Order is delayed, estimated delivery in 3
days.”
              },
              {
```

“exec”:

```
“OrderModification(order_id=‘342293853491’,
modification_type=‘cancel’)”,
                “res”: “Order cancellation option provided.”
              }
            ],
              “resp”: “Your order is delayed, but it's expected to
arrive in 3 days. If you'd prefer to cancel, I can assist with that.”
          }
        }
      ]
    }
  ]
}
```

### Agentic AI Overview

Various embodiments described herein relate generally to artificial intelligence techniques. Generative AI models can be applied in a computing services environment in any of various ways. One way in which generative AI models may be applied involves integrating such models into existing applications. Such models are typically task-specific offering enhancements to core functionalities. For instance, generative AI models may be used to generate emails, service replies, work summaries, and the like. Such models are often tightly integrated into existing, task-specific applications. They often have limited autonomous and interactions driven by user interfaces. Although various details regarding autonomous agents are discussed in this application, additional details are discussed in U.S. patent application Ser. No. 19/037,321 by Kshirsagar et al., filed Jan. 27, 2025, titled Artificial Intelligence Agent Architecture in a Database System”, which is hereby incorporated by reference in its entirety and for all purposes.

According to various embodiments, as AI models became more sophisticated, they became integrated into autonomous agents. Such autonomous agents act as intelligent assistants, capable of understanding and responding to user queries in natural language. Autonomous agents can perform a range of tasks, from providing information to completing complex actions. Autonomous agents are often oriented around a conversational interface and employ an AI agent as the central intelligence. They provide for increased user autonomy and have expanded capabilities beyond task-specific functions.

Various embodiments described herein now provide for a platform that supports multiple agents. Agents may facilitate retrieval augmented generation, topic filtering, headless interfaces, and other complex features. Such agents can operate independently without a user interface, proactively identifying and executing tasks based on predefined goals or real-time data. They can integrate seamlessly with various systems and applications to optimize processes and achieve desired outcomes. Agents can support features such as proactive task initiation and execution, integration with multiple systems, continuous learning and improvement, and automation of complex workflows.

According to various embodiments, different agents may possess different capabilities and knowledge, collectively contributing to the system's overall intelligence. For example, one agent may specialize in data analysis, while another focuses on natural language processing.

In some embodiments, communication by agents can be powered by generative language models. Generative language models can facilitate seamless communication and collaboration among agents, allowing them to share information, coordinate actions, and/or make collective decisions.

In some embodiments, different agents may employ a shared context, which provides a common understanding of the environment, goals, and constraints involved in performing a task. The shared context helps to ensure that different agents can coordinate work towards a unified objective.

In some embodiments, different levels of AI models may be supported in the system. At the lowest level, embedded AI models may perform specific, predefined functions such as generating emails, service replies, work summaries, predicting outcomes based on structured data, classifying input, and the like. At the highest level, an agent can operate independently and autonomously, making decisions and taking actions based on its knowledge and the shared context. This autonomy allows the system to adapt to changing conditions and handle complex tasks. An autonomous agent can move beyond reactive responses and can proactively identify opportunities, anticipate user needs, and initiate actions without explicit prompts. Non-autonomous agents can provide a bridge between embedded AI applications and autonomous agents, facilitating the expansion of their capabilities. By understanding user interactions and preferences, non-autonomous agents can gather valuable data to refine AI models and algorithms, paving the way for greater autonomy.

As one example of an autonomous agent, consider the challenge that conventional sales pipelines are bogged down by time-consuming, inaccurate, and inefficient processes. Sellers spend excessive hours prospecting to generate leads, often employing a scattershot approach that yields low conversion rates. Techniques and mechanisms described herein provide for an autonomous agent configured as a sales development representative that works tirelessly to boost pipeline velocity. The autonomous agent rapidly prioritizes leads, grows pipelines, and reduces manual workload, providing a unified approach to sales orchestration across direct, indirect, and self-service channels.

As another example of an autonomous agent, consider the challenge that sales teams and representatives would like to improve performance and achieve sales targets. Techniques and mechanisms provide for a sales manager coach that offers real-time, data-driven performance analytics, coaching tools, recommendations, and performance metrics for both sales representatives and managers.

As another example, consider the challenges faced by many manufacturing companies, where procurement is in a silo, isolated from manufacturing and also completely disconnected from a customer relationship management system. Accordingly, many procurement organizations manually acquire parts, products, and supplies. Procurement departments are therefore often working with dated information, and are not processing real-time requests from CRM and Manufacturing. To address these problems, an autonomous agent may be configured. Consider the example of a requirement to acquire four specially built tires. Procurement sends an autonomous agent to search for the four tires and autonomously sources them if it finds them. If the autonomous agent can't find them, then it autonomously schedules a production run for the 4 tires, and reaches out to sales to notify the customer about lead time. Data connectors can gather the data sources and provide the data required to identify the available sources, capacity of the production line, and demand. Procurement can either source the part itself or source by the bill of materials. The autonomous agent in the sales dept could also communicate with procurement to procure the required materials and products. Other data sources may include information such as weather, anticipated demand for products, and/or anticipated product failures due to customer neglect (e.g., failure to perform maintenance). Thus, an autonomous agent may combine generative language models with other types of AI models, such as prediction models, a configuration referred to as “blended AI.”

More generally, according to various implementations, the models and/or modules described herein may include classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

According to various embodiments, techniques and mechanisms described herein address a variety of technical challenges, such as adapting generative language models to integrate with computing services environments. Computing services environment provide various types of computing services from a service provider to various client organizations. Examples of such services include, but are not limited to, those directed to customer relations management, sales relations management, supplier relations management, and database management applications. Autonomous agents may help to connect the power and flexibility of generative language models with the power and flexibility of computing services environments. However, existing approaches to autonomous agent configuration and implementation involve manually configuring autonomous agents to perform particular tasks. Such an approach suffers from various drawbacks, such as lack of testability, lack of extensibility, significant development delay, and more. In contrast, techniques and mechanisms described herein provide a set of architectures, frameworks, and methodologies facilitating autonomous agent development and implementation that in various embodiments are extensible, automatable, automated, flexible, and integrated with various computing services environment and generative language model platforms.

According to various embodiments, a computing services environment includes a wide variety of computing services arranged across a wide variety of computing devices in communication with one another. Likewise, a generative language model includes many neurons (e.g., millions, billions, or more) arranged in complex neural networks configured to perform sophisticated generative tasks. Coordinating between such systems involves a host of operations, including those related to processing, communication, architecture, coordination, monitoring, feedback, auditing, logging, and more. Any method performed by a system operating at the intersection of a computing services environment and a generative language model is, therefore, necessarily incapable of being performed in the human mind. In such a context, even a seemingly simple operation involves such a wide range of computing resources that a human mind would be incapable of performing the operation to within a method implemented as described herein. For example, although a human mind is capable of generating text, the human mind is incapable of executing a generative language model to generate text to complete a prompt specified in accordance with one or more embodiments.

### Agent Platform Overview

FIG. 6 illustrates a computing services environment 600, configured in accordance with one or more embodiments. The computing services environment 600 includes an agent platform 602 and other computing services environment components 642. The agent platform 602 includes a unified metadata framework 604, an agent studio 612, an agent library 620, an orchestration, planning, and reasoning layer 626, an action repository 628, a trust layer 630, a model gateway 632, an AI platform 634, a data interface 636, a virtualization interface 638, and a communication interface 640. The agent library 620 includes the agents 622 through 624. The unified metadata framework 604 includes a user interface layer 606, a model layer 608, and a data layer 610. The agent studio 612 includes a prompt studio 614, an assistant studio 616, and an action studio 618.

According to various embodiments, the unified metadata framework 604 may facilitate the configuration of agents as well as interactions between various elements of the computing services environment 600 and the autonomous agent platform 602. For instance, various operations, data objects, and other resources within the computing services environment 600 may be defined as metadata entries within the unified metadata framework 604. Agents may then be constructed using those metadata entries as building blocks.

In some embodiments, the user interface layer 602 facilitates the specification of various applications and workflows 644. Such applications and workflows may include operations performed within and/or outside of the computing services environment 600. For example, applications and workflows may be specific to types of services provided via the computing services environment 600, such as sales, service, marketing, commerce, data analysis, and the like. As another example, applications and workflows may include domain-specific operations, such as those specific to healthcare, finance, or other industries.

In some embodiments, the user interface layer 602 facilitates the specification of agents 646 such as conversational chat assistants. For example, the computing service environment 600 may provide one or more standard conversational chat assistants that may be accessed through user interfaces provided via the computing services environment 600 or via other communication channels such as email, SMS, or external chat services. As another example, an autonomous agent may be customized by, for instance, an organization accessing computing services via the computing services environment 600.

In some embodiments, the agents 646 may be configured to perform various tasks within the system. Examples of agents may include, but are not limited to, customized agents, coaching agents, sales development agents, and customer service agents. Agents may be represented in the unified metadata framework 604 in the user interface layer 606 and may be stored in the agent library 620.

According to various embodiments, one or more of the agents may be autonomous AI agents. Autonomous AI agents (also referred to herein as autonomous agents) may be capable of autonomous or semi-autonomous activation and/or operation. However, not all AI agents are necessarily entirely autonomous. For instance, some AI agents may operate under human control and instruction, for instance eliciting human confirmation before performing some types of actions.

According to various embodiments, an agent may perform operations such as receiving user input, executing one or more applications, workflows, actions, or operations within the computing services environment 600, and/or interacting with a database system, generative language model, other artificial intelligence models, and/or other system accessible via the computing services environment 600.

According to various embodiments, the model layer 604 provides for secure interaction with one or more artificial intelligence models. For instance, the model layer may define access information for performing actions such as retrieving data and accessing AI models via the trust layer 630, the model gateway 632, the AI platform 634, and the data interface 636.

According to various embodiments, the trust layer 630 is configured to perform operations such as masking personally identifying information, securely retrieving data, detecting toxic language generated by a generative language model, and defending prompt completions against injection attacks and other attacks. Thus, the trust layer may provide additional protections for various actions performed in the context of various applications, workflows, and autonomous agents.

In some implementations, the data layer 606 defines data retrievers providing access to data sources, which may be located inside or outside of the computing services environment 600. Examples of such data sources may include, but are not limited to: structured data sources, unstructured data sources, data lakes, vector databases, relational databases, unified user profiles, data-based actions, data warehouses, and data lakehouses.

In some embodiments, an agent may be used to perform one or more tasks within the computing services environment 600. For example, an autonomous agent may interactively converse with a user in natural language. As another example, an agent may interact with one or more artificial intelligence models, including one or more generative language models, one or more predictive models, one or more classification models, and/or one or more other types of models. As yet another example, an autonomous agent may retrieve information from a database system, store information to a database system, transmit one or more messages, and/or take other actions within the computing services environment 600.

In some embodiments, the agent studio 612 allows for the construction and customization of various aspects of the agent platform 600 and/or agents accessible via the agent platform 600. The agent studio 612 may include elements such as a user interface, metadata information, monitoring, governance, and/or search tools for building agents. For example, the agent studio 612 may provide support for constructing one or more prompts, actions, applications, workflows, or the like.

The agent studio 612 includes a prompt studio 614, an assistant studio 616, and an action studio 618. According to various embodiments, the agent studio 612 provides functionality for the configuration of assistants, actions, and prompts to support agent platform customized for a customer organization. For example, a user may build, test, and integrate prompts, actions, and/or autonomous agents into one or more applications provided by or interoperating with the computing services environment 600 to support the performance of various tasks for an organization.

Agents 622 through 624 may be stored in the agent library 604. One or more agents may be configured in a standardized format and/or template for use by various organizations and individuals accessing computing services via the computing services environment 600. Additionally, one or more agents may be customized for particular industries, organizations, individuals, applications, and/or other contexts.

At 626, an orchestration, planning, and reasoning layer provides for the execution of an agent to interpret, decompose, and implement actions based on user inputs. For example, a user instruction such as “draft an email summarizing this record” may be analyzed to identify an overall intent. The user instruction may also be decomposed into actions such as “summarize a record” and “draft an email using the summary”. The decomposition and overall intent may be used to orchestrate and execute a plan, which may involve identifying the focal record, determining and completing one or more prompts to determine the summary, and determining and completing one or more prompts to draft an email using the summary. Additional details regarding the formulation and execution of such a plan are discussed throughout the application.

According to various embodiments, the action repository 628 may include one or more actions that are preconfigured to perform tasks within the computing services environment 600. For instance, an action repository may include actions such as “summarize a record” or “draft an email.” An autonomous agent may identify and execute such actions in order to implement a user's intent or accomplish other objectives assigned to the autonomous agent.

In some embodiments, one or more of the actions may be specific to a particular domain. For instance, one or more actions in the health or finance domains may include particular constraints, such as instructions provided to a generative language model, to provide for compliance with relevant laws and regulations.

In some embodiments, one or more of the actions may be configurable and/or user-defined. For instance, a user associated with an organization accessing computing services via the computing services environment 600 may provide code and/or other action definition information specifying an action to be performed. The defined action may then be incorporated into an orchestration or workflow.

The model gateway 632 provides access to one or more generative language models or other artificial intelligence models. In some embodiments, agents may be supported by a range of different generative language models. For example, a customer organization may be able to use standardized models provided by model providers such as Open AI, Microsoft Azure, Gemini, or the like. As another example, the model gateway 632 may also support customized models, for instance models customized and/or hosted by a customer organization. As yet another example, the model gateway 632 may provide access to models hosted within the computing service environment 600.

In some embodiments, an AI agent may be configured to employ different models for different aspects of the agent. For example, one model (e.g., Gemini) may be used for a function such as “summarize record”, while another model (e.g., Open AI) may be used for a function such as “draft email”. In this way, an AI agent may be flexibly adapted to execute a variety of different operations.

In some embodiments, the model gateway 632 may provide a feedback framework for receiving user feedback. The user feedback may be stored in the database and may be used for a variety of purposes, such as finetuning an autonomous agent and/or one or more of the underlying generative language models.

The AI platform 634 may provide support for generative language models and other types of AI models hosted by the service provider of the computing services environment 600 and/or one or more partner or customer organizations. For example, the customer organization may provide their own generative language model, such as a hosted generative language model. As another example, the customer may employ a customer-tuned version of a standard model, such as the customer's version of a model provided by Azure or Gemini. As still another example, an agent may employ a standard generative language model hosted by the service provider of the computing services environment 600.

The data interface 636 provides access to one or more of a variety of data sources. According to various embodiments, an agent may access one or more data sources to support the autonomous agent operations. For example, an agent may access third party data sources such as Google Cloud, Google BigQuery, Amazon S3, or Microsoft Azure. As another example, an agent may access one or more data sources from inside the computing services environment, such as customer relations management data. As still another example, an agent may access data from other sources, such as legacy systems, external apps, mobile sources, web sources, software development kids, and/or application procedure interfaces. Examples of data interfaces may include, but are not limited to: data lakehouses, real-time data services, zero-ETL data services, united profiles, data actions, data connectors, relational database systems, and any other interfaces for accessing structured, unstructured, or semi-structured data sources.

At 638, a virtualization platform provides for the ability to deploy one or more aspects of the platform provided via the computing services environment in one or more virtual environments. For example, data residency requirements may be enforced, ensuring that data resides in a particular location. As another example, communications may be encrypted end-to-end. As still another example, one or more regulatory requirements may be enforced. The virtualization platform 638 may allow all or a portion of the computing services environment 600 to be deployed in a different location, such as within a hosted environment (e.g., Google Compute, Amazon AWS, etc.).

The communication interface 640 facilitates communication with one or more client machines via any of various communication channels. For example, depending on the system configuration, a client machine may communicate with an autonomous agent via a web interface, a messaging application (e.g., Slack), email, voice, SMS messages, and/or any other suitable communication channel. Some such channels may be embedded into other applications, such as web applications accessible via the computing services environment 600 or native applications accessed via a client machine.

According to various embodiments, as shown in the other computing services environment components 642, the computing services environment 600 may include various elements and components other than those shown in FIG. 6.

FIG. 7 illustrates a method 700 providing an overview of the lifecycle of an autonomous agent, performed in accordance with one or more embodiments. According to various embodiments, the method 700 may be performed at a computing services environment such as the computing services environment 600 shown in FIG. 6.

At 702, an autonomous agent is defined by specifying a set of metadata entries in a metadata framework within the computing services environment. The metadata entries may be stored in a database system within the computing services environment. The metadata entries may include a set of action definitions defining actions capable of being taken by the autonomous agent within the computing services environment. The metadata entries may also include a triggering condition for triggering the autonomous agent.

In some embodiments, the agent and/or one or more of the actions may be defined by the service provider of the computing services environment. Alternatively, or additionally, the agent and/or one or more of the actions may be customized by a client accessing computing services via the computing services environment. In such a configuration, the customized autonomous agent may be specific to the client and may be unavailable to other clients accessing computing services within the computing services environment.

In some embodiments, an autonomous agent may be configured for operation within a portion of the computing services environment. For instance, the autonomous agent may be configured to operate within one or more on-demand computing applications, computing clouds, chat interfaces, operational contexts, data sets, data object types, or the like.

In some embodiments, the triggering condition may include an explicit request by a user to instantiate the autonomous agent. For instance, the autonomous agent may be instantiated based on one or more natural language user instructions received via a communication channel. Alternatively, or additionally, the triggering condition may specify one or more conditions under which the autonomous agent is autonomously instantiated. For example, the autonomous agent may be instantiated automatically when a database record is created or updated with a database field value that meets one or more defined characteristics. As another example, the autonomous agent may be instantiated automatically by a workflow within the computing services environment 100. As yet another example, the autonomous agent may be instantiated upon request as part of the execution of a different autonomous agent.

The autonomous agent is autonomously instantiated at 704 upon the detection of the triggering condition within the computing services environment. The triggering condition and hence the instantiation of the autonomous agent may be associated with a context for operating the autonomous agent. The context may specify one or more elements of an initial state of the autonomous agent. For instance, the context may identify information such as a client organization, a user account, natural language input received via a communication channel.

An execution plan is determined at 706 by selecting a subset of the actions based on the context. The execution plan may be determined by formulating a prompt for completion by a generative language model. The prompt may include information such as a set of action descriptions and action identifiers, as well as information associated with the context such as natural language user input. The prompt may include instructions to generate text including identifiers for actions that are selected by the generative language model based on the context, the instructions, and the action descriptions.

In some embodiments, determining the execution plan may involve multiple operations, executed in sequence or in parallel. For example, a particular planner and/or agent of a set of available planners and/or agents may first be selected. As another example, a topic or topics may be selected from a set of available topics, and the actions available for selection may be first filtered to the topic or topics. Such an approach may reduce the number of action descriptions that need to be included in the plan determination prompt that is completed by the generative language model to determine the plan.

The subset of actions are executed within the computing services environment 100 at 708. Executing the actions may involve performing any of a variety of operations. In particular, one or more data records stored within the database system within the computing services environment may be updated. Other examples of the types of operations that may be performed may include, but are not limited to: retrieving data from inside and/or outside the computing services environment, determining novel text, updating computing services environment logging data, executing one or more artificial intelligence and/or machine learning models inside and/or outside the computing services environment, transmitting messages to communicate with client machines and/or other devices, and the like. As discussed herein, an action may potentially include any operation or operations capable of being performed within the computing services environment.

The method 700 provides a general overview of the operations that may be performed in the lifecycle of an autonomous agent. Additional details regarding these operations, such as the creation of an autonomous agent, the instantiation of an autonomous agent, the determination of an execution plan, and the execution of the actions within an execution plan, are discussed throughout the application.

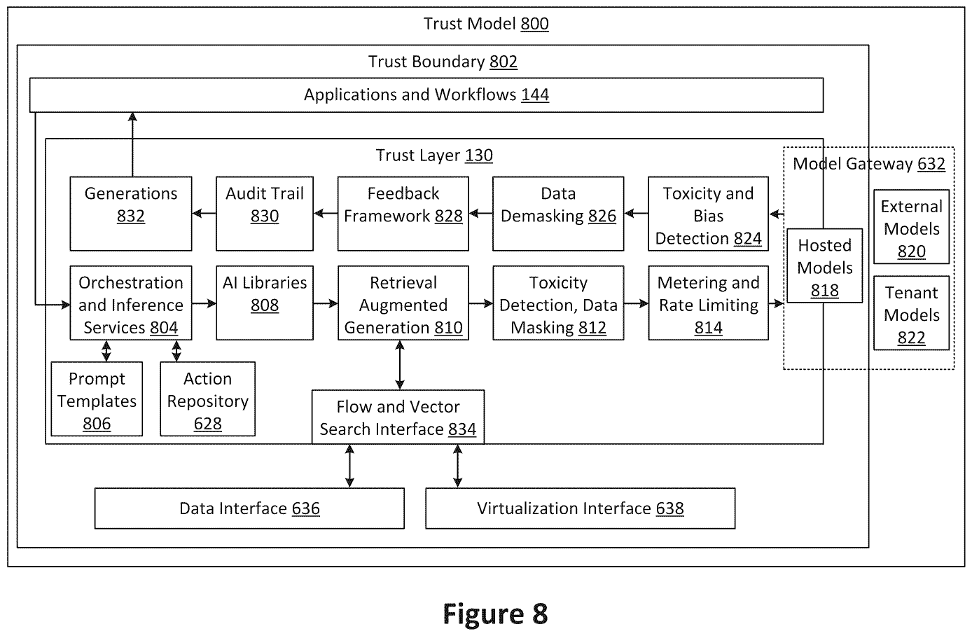

FIG. 8 illustrates a trust model 800 for the autonomous agent platform, configured in accordance with one or more embodiments. The trust model 800 includes a trust boundary 802. Inside the trust boundary 802 are the applications and workflows 644, the trust layer 630, the data interface 636, and the virtualization interface 638.

In some embodiments, the trust boundary 802 may separate internal from external services. Inside the trust boundary, at 206, a trust layer may provide for the execution of various trust related operations. Outside the trust boundary, one or more external services or models may operate in an untrusted zone or a zone of shared trust.

The trust layer 630 includes one or more orchestration and inference services 804, one or more artificial intelligence libraries 808, one or more retrieval augmented generation services 810, one or more inbound toxicity detection and/or data masking services 812, one or more metering and rate limiting services 814, one or more outbound toxicity and bias detection services 824, one or more data demasking services 826, a feedback framework 828, an audit trail service 830, generations 832, prompt templates 806, and a one or more flow and/or vector search services 834.

For the purpose of illustration, the trust model 800 is shown with arrows illustrating a simple flow that may employ various components. In practice, however, the trust layer 630 may be used to perform various types of complex operations that may operate outside the linear flow illustrated in the trust model 800. However, the simple flow shown in FIG. 8 may be used to understand the operation and interaction of the various elements included in the trust layer 630.

For the purpose of illustration, consider a request generated by one or more applications and workflows 644. For instance, the request may be natural language text input provided by a user, an operation instruction triggered by an action performed in the context of an application, or some other type of request. Such a request may be sent to the orchestration and inference services 804.

According to various embodiments, the orchestration and inference services 804 may analyze the request to determine an intent, execute one or more actions, generate novel text, interact with the database system, receive and/or transmit one or more messages, and/or perform other types of operations. In service of performing these operations, the orchestration and inference services 804 may access one or more prompt templates 806, one or more actions stored in the action repository 628, and/or other preconfigured definitions or templates.

According to various embodiments, the orchestration and inference services 804 may transmit information to one or more artificial intelligence libraries 808, which may trigger the retrieval of information via the one or more retrieval augmented generation services 810. The one or more retrieval augmented generation services 810 may retrieve information from inside and/or outside of the computing services environment via the data interface 636 and/or the virtualization interface 638 through the flow and/or vector search interface 834. Retrieved information may be added to a prompt template or used to perform an action.

In some embodiments, prompts and other requests to artificial intelligence models may be processed via one or more toxicity detection and/or data masking services 812. Toxicity detection services, bias detection services, and/or other such evaluators may seek to determine whether a request is likely to generate text or other output deemed biased, offensive, or otherwise unacceptable or impermissible. Data masking may replace some information, such as personally identifying information, with blanks, unique identifiers, or other such values.

In some implementations, requests may be further processed via one or more metering and/or rate limiting services 814. Metering and/or rate limiting services 814 may help to ensure that requests to models do not exceed a designated rate. For instance, one or more requests may be queued to ensure that a request rate for a designated model, user, organization, or other context does not exceed a designated threshold.

In some implementations, requests to models may be sent via the model gateway 632. According to various embodiments, the model gateway 632 may be used to access one or more hosted models 818 hosted by the computing services environment 600, one or more tenant models 822 hosted by a customer organization, and/or one or more external models 820 hosted by a third-party service provider. Depending on the configuration, different models may reside inside of the trust layer, outside of the trust layer, and/or in an intermediate zone such as a shared trust environment.

In some embodiments, responses from models, such as prompt completions generated by a generative language model, may be evaluated for toxicity and bias by one or more toxicity and/or bias detection services at 824. Such evaluation may help to ensure that the system does not perform operations or return text that includes impermissible, objectionable, offensive content.

According to various embodiments, data demasking may be performed at 826. For instance, personally identifying information in an input prompt to a generative language model may be replaced with randomly generated unique identifiers by one or more data masking services 812. Then, when the generative language model returns a prompt completion that includes one or more of the randomly generated unique identifiers, the identifiers may be replaced with the personally identifying information. In this way, the system may generate text and/or take other actions that include or reflect personally identifying information, while at the same time not exposing such information to services outside the trust model such as externally hosted generative language models.

In some embodiments, feedback regarding actions, text generated by large language models, and/or other such operations may be determined and stored via the feedback framework 828. Such information may be used to train models, guide subsequent actions, and/or otherwise refine the operations of an autonomous agent.

In some implementations, the audit trail service 830 may aggregate and store information used to provide a record of actions taken by the system in the course of executing operations associated with an autonomous agent. Such information may be stored in a database system accessible via the computing services environment 600.

In some embodiments, text and other output generated as part of the processing of requests from the requests and workflows 608 may be returned to the applications and workflows 608 as generations at 832. Generations 832 may include, but are not limited to: text to be presented in a chat interface, instructions regarding actions to be performed in the context of providing an application or workflow, or other such information.

In some implementations, generations may be extracted from novel text generated by a generative language model. For instance, a generative language model may be provided with a prompt that includes information such as: (1) one or more natural language instructions to be executed by the generative language model, (2) input data to be used by the generative language model as needed in the course of executing the one or more natural language instructions, (3) one or more parameters governing the execution of the one or more natural language instructions, (4) any other information. The input data may include text data, structured data, unstructured data, or any other type of data. The generative language model may then execute the one or more natural language instructions to generate novel text.

In some embodiments, the novel text may include natural language, such as natural language to include in a message to a user, a field in a database record, a computing services environment log, or the like. Alternatively, or additionally, the novel text may include data, such as numerical data to use in updating a database record, data indicating a selection of one or more computing resources and elements within the computing services environment. For example, computing resources and elements such as topics, actions, computing devices, clients, users, and more may be associated with corresponding unique identifiers. The generative language model may generate novel text that includes such unique identifiers. The unique identifiers may then be extracted from the novel text by the computing services environment and used to trigger and/or inform the performance of operations within the computing services environment.

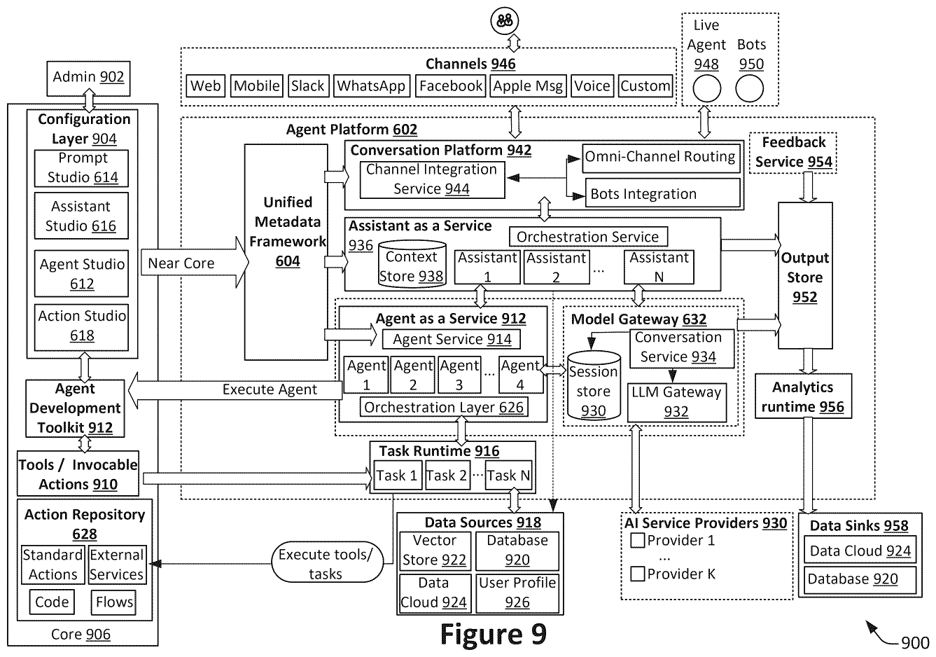

FIG. 9 illustrates an architecture diagram 900 of elements of the computing services environment 600, configured in accordance with one or more embodiments. The architecture diagram 900 is provided to illustrate additional details related to the operation of the computing services environment 600 with respect to the agent platform 602.

In the architecture diagram 900, an administrator 902 or other user interacts with an agent configuration layer 904 within the core 906 of the computing services environment. The configuration layer includes various elements, discussed in FIG. 6, for configuring agents. Collectively these tools provide access to an agent development toolkit 912 for defining and configuring tools and invocable actions 910 within the computing services environment. An agent may be composed of metadata references to such tools and invocable actions 910, as well as other metadata entries.

According to various embodiments, metadata entries may be specified within the unified metadata framework 604 within the agent platform 602. The metadata entries may be used to specify actions and operations associated with elements within the agent platform 602 used to provide the agents.

In some implementations, as a central element, the agent as a service platform 912 provides for the instantiation and execution of agents via the agent service 914. The orchestration layer 626 may be used to perform operations such as selecting agents, selecting planners, and determining plans. When an agent performs an action, the action may be implemented as a task executed by the task runtime 916.

In some embodiments, executing a task may involve retrieving data from one or more of the data sources 918. The data sources 918 may include a variety of data sources inside and/or outside of the computing services environment 600, including the database system 920, a vector store 922, a data cloud 924 providing access to, for instance, unstructured data, and user profiles 926.

In some embodiments, as another central element, the agent as a service platform 912 may coordinate with the model gateway 628 to communicate with generative language models and/or other artificial intelligence and/or machine learning models. The conversation service 934 may coordinate the generation of natural language text via the LLM gateway 932. The service platform 912 may communicate with AI service providers 930, which may be located inside or outside of the computing services environment 600.

According to various embodiments, as a particular kind of agent, conversational chat assistants may be accessed via the assistant as a service platform 936. Information pertaining to instances of conversational chat assistants may be stored in the context store 938. For instance, records of conversations as well as other supporting metadata may be used to save the state of a conversational chat assistant and then restore the state at a later point in time. A conversational chat assistant orchestration service 940 may coordinate operations of conversational chat assistants, including communication via the conversation platform 942. The conversation platform 942 may coordinate communication via various communication channels 946 via a channel integration service 944. Any of a variety of communication channels may be supported, including custom channels defined by customer organizations of the computing services environment 600. The conversation platform 942 may also support agent interactions with human agents 948 and/or computing programs 950 located outside of the agent platform 602.

According to various embodiments, information determined by the agents may be stored to an output store 952. Feedback regarding agent performance may be provided via a feedback service 954, and information analyzed via an analytics runtime 956 may be stored to one or more data sinks 958, such as the database system 920 and/or the data cloud 924.

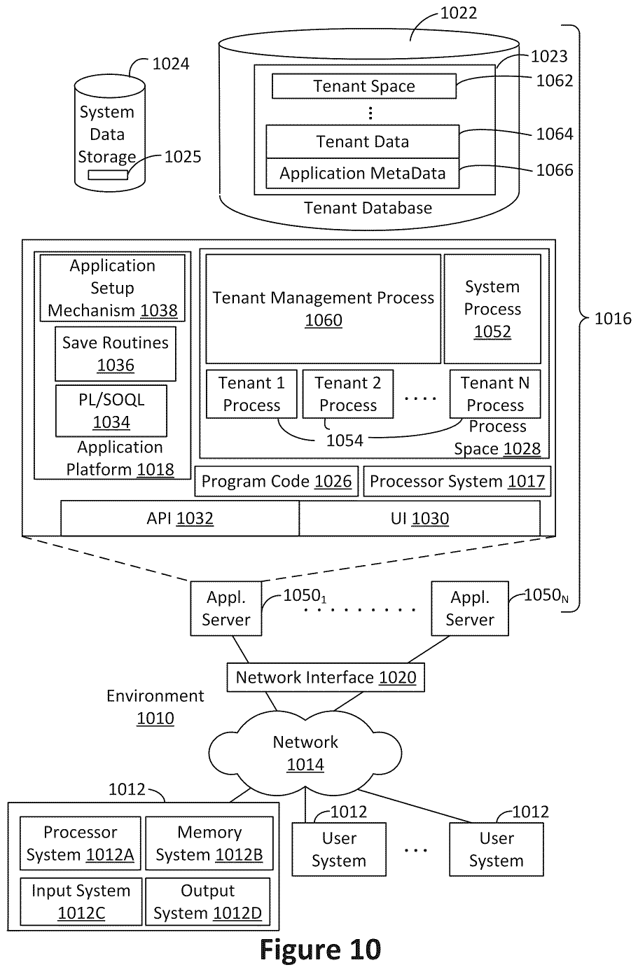

FIG. 10 shows a block diagram of an example of an environment 1010 that includes an on-demand database service configured in accordance with some implementations. Environment 1010 may include user systems 1012, network 1014, database system 1016, processor system 1017, application platform 1018, network interface 1020, tenant data storage 1022, tenant data 1023, system data storage 1024, system data 1025, program code 1026, process space 1028, User Interface (UI) 1030, Application Program Interface (API) 1032, PL/SOQL 1034, save routines 1036, application setup mechanism 1038, application servers 1050-1 through 1050-N, system process space 1052, tenant process spaces 1054, tenant management process space 1060, tenant storage space 1062, user storage 1064, and application metadata 1066. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

According to various embodiments, the environment 1010 may provide access to an agent platform. As shown in FIG. 10, the environment 1010 may also include other elements beyond the agent platform, such as computing components used to provide other types of computing services. Agents accessible via the agent platform may interoperate with such computing services. For instance, agents may trigger, configure, be triggered by, and/or accessed via such computing services.

An on-demand database service, implemented using system 1016, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 1018 may be a framework that allows the creation, management, and execution of applications in system 1016. Such applications may be developed by the database service provider or by users or third-party application developers accessing the service. Application platform 1018 includes an application setup mechanism 1038 that supports application developers'creation and management of applications, which may be saved as metadata into tenant data storage 1022 by save routines 1036 for execution by subscribers as one or more tenant process spaces 1054 managed by tenant management process 1060 for example. Invocations to such applications may be coded using PL/SOQL 1034 that provides a programming language style interface extension to API 1032. A detailed description of some PL/SOQL language implementations is discussed in commonly assigned U.S. Pat. No. 10,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 1066 for a subscriber making such an invocation. Such system processes may also manage execution of application metadata 1066 as an application in a virtual machine.

In some implementations, each application server 1050 may handle requests for any user associated with any organization. A load balancing function (e.g., an F5 Big-IP load balancer) may distribute requests to the application servers 1050 based on an algorithm such as least-connections, round robin, observed response time, etc. Each application server 1050 may be configured to communicate with tenant data storage 1022 and the tenant data 1023 therein, and system data storage 1024 and the system data 1025 therein to serve requests of user systems 1012. The tenant data 1023 may be divided into individual tenant storage spaces 1062, which can be either a physical arrangement and/or a logical arrangement of data. Within each tenant storage space 1062, user storage 1064 and application metadata 1066 may be similarly allocated for each user. For example, a copy of a user's most recently used (MRU) items might be stored to user storage 1064. Similarly, a copy of MRU items for an entire tenant organization may be stored to tenant storage space 1062. A UI 1030 provides a user interface and an API 1032 provides an application programming interface to system 1016 resident processes to users and/or developers at user systems 1012.

System 1016 may implement a web-based generative language model system. For example, in some implementations, system 1016 may include application servers configured to implement and execute generative language model software applications. The application servers may be configured to provide related data, code, forms, web pages and other information to and from user systems 1012. Additionally, the application servers may be configured to store information to, and retrieve information from a database system. Such information may include related data, objects, and/or Webpage content. With a multi-tenant system, data for multiple tenants may be stored in the same physical database object in tenant data storage 1022, however, tenant data may be arranged in the storage medium(s) of tenant data storage 1022 so that data of one tenant is kept logically separate from that of other tenants. In such a scheme, one tenant may not access another tenant's data, unless such data is expressly shared.

Several elements in the system shown in FIG. 10 include conventional, well-known elements that are explained only briefly here. For example, user system 1012 may include processor system 1012A, memory system 1012B, input system 1012C, and output system 1012D. A user system 1012 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 1012 to access, process and view information, pages and applications available from system 1016 over network 1014. Network 1014 may be any network or combination of networks of devices that communicate with one another, such as any one or any combination of a LAN (local area network), WAN (wide area network), wireless network, or other appropriate configuration.

The users of user systems 1012 may differ in their respective capacities, and the capacity of a particular user system 1012 to access information may be determined at least in part by “permissions” of the particular user system 1012. As discussed herein, permissions generally govern access to computing resources such as data objects, components, and other entities of a computing system, such as a generative language model platform, a social networking system, and/or a CRM database system. “Permission sets” generally refer to groups of permissions that may be assigned to users of such a computing environment. For instance, the assignments of users and permission sets may be stored in one or more databases of System 1016. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 1016 may provide on-demand database service to user systems 1012 using an MTS arrangement. By way of example, one tenant organization may be a company that employs a sales force where each salesperson uses system 1016 to manage their sales process. Thus, a user in such an organization may maintain contact data, leads data, customer follow-up data, performance data, goals and progress data, etc., all applicable to that user's personal sales process (e.g., in tenant data storage 1022). In this arrangement, a user may manage his or her sales efforts and cycles from a variety of devices, since relevant data and applications to interact with (e.g., access, view, modify, report, transmit, calculate, etc.) such data may be maintained and accessed by any user system 1012 having network access.

When implemented in an MTS arrangement, system 1016 may separate and share data between users and at the organization-level in a variety of manners. For example, for certain types of data each user's data might be separate from other users'data regardless of the organization employing such users. Other data may be organization-wide data, which is shared or accessible by several users or potentially all users form a given tenant organization. Thus, some data structures managed by system 1016 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 1016 may also maintain system-level data usable by multiple tenants or other data. Such system-level data may include industry reports, news, postings, and the like that are sharable between tenant organizations.

In some implementations, user systems 1012 may be client systems communicating with application servers 1050 to request and update system-level and tenant-level data from system 1016. By way of example, user systems 1012 may send one or more queries requesting data of a database maintained in tenant data storage 1022 and/or system data storage 1024. An application server 1050 of system 1016 may automatically generate one or more SQL statements (e.g., one or more SQL queries) that are designed to access the requested data. System data storage 1024 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 10,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

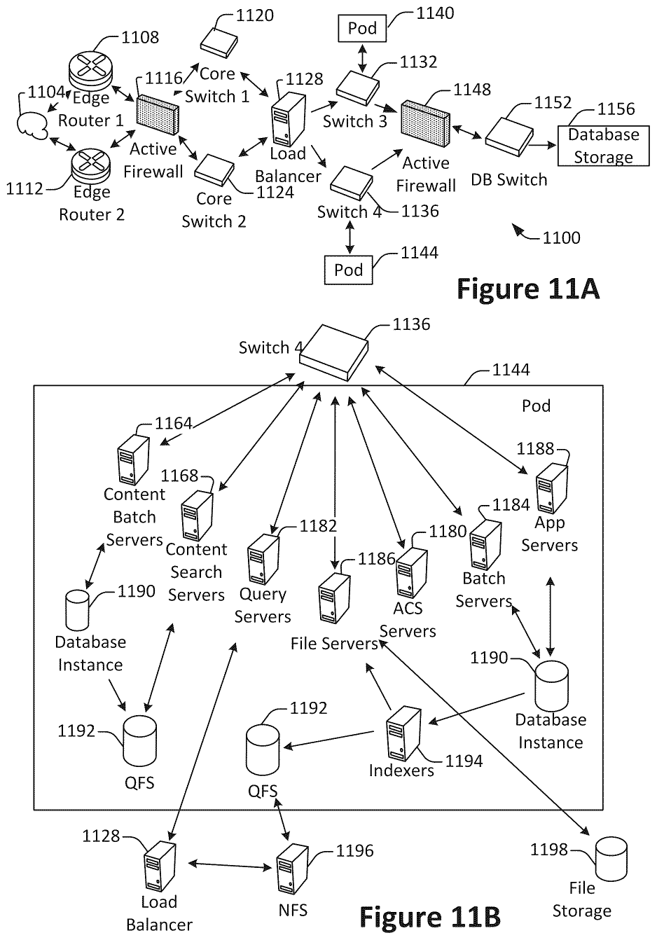

FIG. 11A shows a system diagram of an example of architectural components of an on-demand database service environment 1100, configured in accordance with some implementations. A client machine located in the cloud 1104 may communicate with the on-demand database service environment via one or more edge routers 1108 and 1112. A client machine may include any of the examples of user systems 1012 described above. The edge routers 1108 and 1112 may communicate with one or more core switches 1120 and 1124 via firewall 1116. The core switches may communicate with a load balancer 1128, which may distribute server load over different pods, such as the pods 1140 and 1144 by communication via pod switches 1132 and 1136. The pods 1140 and 1144, which may each include one or more servers and/or other computing resources, may perform data processing and other operations used to provide on-demand services. Components of the environment may communicate with a database storage 1156 via a database firewall 1148 and a database switch 1152.

Accessing an on-demand database service environment may involve communications transmitted among a variety of different components. The environment 1100 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 11A and 11B.

The cloud 1104 refers to any suitable data network or combination of data networks, which may include the Internet. Client machines located in the cloud 1104 may communicate with the on-demand database service environment 1100 to access services provided by the on-demand database service environment 1100. By way of example, client machines may access the on-demand database service environment 1100 to retrieve, store, edit, and/or process generative language model information.

In some implementations, the edge routers 1108 and 1112 route packets between the cloud 1104 and other components of the on-demand database service environment 1100. The edge routers 1108 and 1112 may employ the Border Gateway Protocol (BGP). The edge routers 1108 and 1112 may maintain a table of IP networks or ‘prefixes’, which designate network reachability among autonomous systems on the internet.

In one or more implementations, the firewall 1116 may protect the inner components of the environment 1100 from internet traffic. The firewall 1116 may block, permit, or deny access to the inner components of the on-demand database service environment 1100 based upon a set of rules and/or other criteria. The firewall 1116 may act as one or more of a packet filter, an application gateway, a stateful filter, a proxy server, or any other type of firewall.

In some implementations, the core switches 1120 and 1124 may be high-capacity switches that transfer packets within the environment 1100. The core switches 1120 and 1124 may be configured as network bridges that quickly route data between different components within the on-demand database service environment. The use of two or more core switches 1120 and 1124 may provide redundancy and/or reduced latency.

In some implementations, communication between the pods 1140 and 1144 may be conducted via the pod switches 1132 and 1136. The pod switches 1132 and 1136 may facilitate communication between the pods 1140 and 1144 and client machines, for example via core switches 1120 and 1124. Also or alternatively, the pod switches 1132 and 1136 may facilitate communication between the pods 1140 and 1144 and the database storage 1156. The load balancer 1128 may distribute workload between the pods, which may assist in improving the use of resources, increasing throughput, reducing response times, and/or reducing overhead. The load balancer 1128 may include multilayer switches to analyze and forward traffic.

In some implementations, access to the database storage 1156 may be guarded by a database firewall 1148, which may act as a computer application firewall operating at the database application layer of a protocol stack. The database firewall 1148 may protect the database storage 1156 from application attacks such as structure query language (SQL) injection, database rootkits, and unauthorized information disclosure. The database firewall 1148 may include a host using one or more forms of reverse proxy services to proxy traffic before passing it to a gateway router and/or may inspect the contents of database traffic and block certain content or database requests. The database firewall 1148 may work on the SQL application level atop the TCP/IP stack, managing applications'connection to the database or SQL management interfaces as well as intercepting and enforcing packets traveling to or from a database network or application interface.

In some implementations, the database storage 1156 may be an on-demand database system shared by many different organizations. The on-demand database service may employ a single-tenant approach, a multi-tenant approach, a virtualized approach, or any other type of database approach. Communication with the database storage 1156 may be conducted via the database switch 1152. The database storage 1156 may include various software components for handling database queries. Accordingly, the database switch 1152 may direct database queries transmitted by other components of the environment (e.g., the pods 1140 and 1144) to the correct components within the database storage 1156.

FIG. 11B shows a system diagram further illustrating an example of architectural components of an on-demand database service environment, in accordance with some implementations. The pod 1144 may be used to render services to user(s) of the on-demand database service environment 1100. The pod 1144 may include one or more content batch servers 1164, content search servers 1168, query servers 1182, file servers 1186, access control system (ACS) servers 1180, batch servers 1184, and app servers 1188. Also, the pod 1144 may include database instances 1190, quick file systems (QFS) 1192, and indexers 1194. Some or all communication between the servers in the pod 1144 may be transmitted via the switch 1136.

In some implementations, the app servers 1188 may include a framework dedicated to the execution of procedures (e.g., programs, routines, scripts) for supporting the construction of applications provided by the on-demand database service environment 1100 via the pod 1144. One or more instances of the app server 1188 may be configured to execute all or a portion of the operations of the services described herein.

In some implementations, as discussed above, the pod 1144 may include one or more database instances 1190. A database instance 1190 may be configured as an MTS in which different organizations share access to the same database, using the techniques described above. Database information may be transmitted to the indexer 1194, which may provide an index of information available in the database 1190 to file servers 1186. The QFS 1192 or other suitable filesystem may serve as a rapid-access file system for storing and accessing information available within the pod 1144. The QFS 1192 may support volume management capabilities, allowing many disks to be grouped together into a file system. The QFS 1192 may communicate with the database instances 1190, content search servers 1168 and/or indexers 1194 to identify, retrieve, move, and/or update data stored in the network file systems (NFS) 1196 and/or other storage systems.

In some implementations, one or more query servers 1182 may communicate with the NFS 1196 to retrieve and/or update information stored outside of the pod 1144. The NFS 1196 may allow servers located in the pod 1144 to access information over a network in a manner similar to how local storage is accessed. Queries from the query servers 1122 may be transmitted to the NFS 1196 via the load balancer 1128, which may distribute resource requests over various resources available in the on-demand database service environment 1100. The NFS 1196 may also communicate with the QFS 1192 to update the information stored on the NFS 1196 and/or to provide information to the QFS 1192 for use by servers located within the pod 1144.

In some implementations, the content batch servers 1164 may handle requests internal to the pod 1144. These requests may be long-running and/or not tied to a particular customer, such as requests related to log mining, cleanup work, and maintenance tasks. The content search servers 1168 may provide query and indexer functions such as functions allowing users to search through content stored in the on-demand database service environment 1100. The file servers 1186 may manage requests for information stored in the file storage 1198, which may store information such as documents, images, basic large objects (BLOBs), etc. The query servers 1182 may be used to retrieve information from one or more file systems. For example, the query system 1182 may receive requests for information from the app servers 1188 and then transmit information queries to the NFS 1196 located outside the pod 1144. The ACS servers 1180 may control access to data, hardware resources, or software resources called upon to render services provided by the pod 1144. The batch servers 1184 may process batch jobs, which are used to run tasks at specified times. Thus, the batch servers 1184 may transmit instructions to other servers, such as the app servers 1188, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

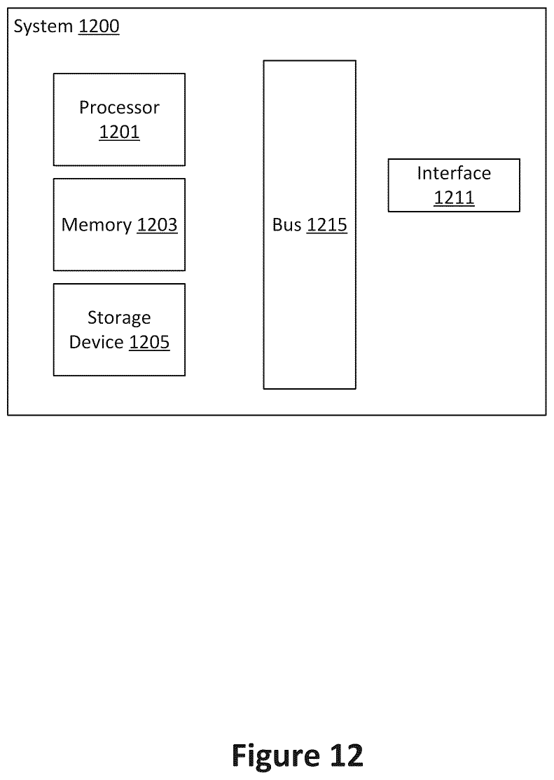

FIG. 12 illustrates one example of a computing device. According to various embodiments, a system 1200 suitable for implementing embodiments described herein includes a processor 1201, a memory module 1203, a storage device 1205, an interface 1211, and a bus 1215 (e.g., a PCI bus or other interconnection fabric.) System 1200 may operate as variety of devices such as an application server, a database server, or any other device or service described herein. Although a particular configuration is described, a variety of alternative configurations are possible. The processor 1201 may perform operations such as those described herein. Instructions for performing such operations may be embodied in the memory 1203, on one or more non-transitory computer readable media, or on some other storage device. Various specially configured devices can also be used in place of or in addition to the processor 1201. The interface 1211 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

### Conclusion

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of JSON. However, the techniques of the present invention apply to a wide variety of formatting configurations. Particular embodiments may be implemented without some or all of the specific details described herein. In other instances, well known process operations have not been described in detail in order not to unnecessarily obscure the present invention. Accordingly, the breadth and scope of the present application should not be limited by any of the implementations described herein, but should be defined only in accordance with the claims and their equivalents.

1. A computing services environment comprising:
a relational database system storing a plurality of database records corresponding to text-based interactions between individuals and human agents;
a unified metadata framework including a plurality of autonomous agent definitions;
an agent creation engine configured to create and store an autonomous agent definition in accordance with the unified metadata framework by iteratively selecting a database record from the plurality of database records and determining autonomous agent definition update information based on text included in the database record, the autonomous agent definition referencing a plurality of action definitions defining a plurality of actions capable of being performed within the computing services environment;
an agent service configured to instantiate an autonomous agent instance based on the autonomous agent definition; and
an orchestration layer configured to determine an orchestration plan based on novel planning text generated by a generative language model based on the autonomous agent definition, the orchestration plan including a subset of the plurality of actions identified in the novel planning text, the computing services environment being configured to execute the subset of the plurality of actions.

2. The computing services environment recited in claim 1, wherein determining the autonomous agent definition update information comprises:
transmitting a reasoning input prompt to the generative language model, the reasoning input prompt including natural language chat text selected from the database record, the reasoning input prompt also including natural language reasoning instructions to identify one or more modifications to a pre-existing autonomous agent definition based on the natural language chat text; and
determining the autonomous agent definition update information based on novel natural language reasoning output text generated by the generative language model responsive to the reasoning input prompt.

3. The computing services environment recited in claim 1, wherein the agent creation engine is further configured to determine simulated autonomous agent output data, the simulated autonomous agent output data simulating a result obtained by applying a simulated autonomous agent instance incorporating the autonomous agent definition update information to natural language chat text selected from the database record.

4. The computing services environment recited in claim 3, wherein the simulated autonomous agent output data is determined by a procedural simulation of the generative language model.

5. The computing services environment recited in claim 3, wherein the simulated autonomous agent output data is determined without invoking the generative language model.

6. The computing services environment recited in claim 1, wherein the plurality of database records is sorted in accordance with one or more quality or performance metrics, and wherein the database record is selected based on the one or more quality or performance metrics.

7. The computing services environment recited in claim 6, wherein the one or more quality or performance metrics reflect one or more characteristics of human agents associated with the plurality of database records.

8. The computing services environment recited in claim 1, wherein the autonomous agent definition update information includes a patch implemented in accordance with JavaScript Object Notation.

9. The computing services environment recited in claim 8, wherein the agent creation engine is configured to determine the patch by iteratively communicating with the generative language model to determine a proposed patch based on a natural language description of patch information to include in the proposed patch and attempting to apply the proposed patch to a pre-existing autonomous agent definition.

10. The computing services environment recited in claim 9, wherein an updated patch is determined upon identifying a failure condition when attempting to apply the proposed patch to the pre-existing autonomous agent definition.

11. The computing services environment recited in claim 9, wherein the agent creation engine is configured to determine the patch by communicating with the generative language model to evaluate whether the proposed patch accurately reflects the natural language description of patch information to include in the proposed patch.

12. The computing services environment recited in claim 11, wherein an updated patch is determined upon determining that the proposed patch does not accurately reflect the natural language description of the patch information to include in the proposed patch.

13. The computing services environment recited in claim 1, wherein the agent creation engine is configured to automatically determine one or more test cases from the database record for application to subsequently selected database records.

14. A method comprising:
storing a plurality of database records in a relational database system, the plurality of database records corresponding to text-based interactions between individuals and human agents;
creating and storing an autonomous agent definition via a an agent creation engine in accordance with a unified metadata framework including a plurality of autonomous agent definitions, the autonomous agent definition being created by iteratively selecting a database record from the plurality of database records and determining autonomous agent definition update information based on text included in the database record, the autonomous agent definition referencing a plurality of action definitions defining a plurality of actions capable of being performed within the computing services environment;
instantiating an autonomous agent instance at an agent service based on the autonomous agent definition; and
determining and executing an orchestration plan at an orchestration layer based on novel planning text generated by a generative language model based on the autonomous agent definition, the orchestration plan including a subset of the plurality of actions identified in the novel planning text, the computing services environment being configured to execute the subset of the plurality of actions.

15. The method recited in claim 14, wherein determining the autonomous agent definition update information comprises:
transmitting a reasoning input prompt to the generative language model, the reasoning input prompt including natural language chat text selected from the database record, the reasoning input prompt also including natural language reasoning instructions to identify one or more modifications to a pre-existing autonomous agent definition based on the natural language chat text; and
determining the autonomous agent definition update information based on novel natural language reasoning output text generated by the generative language model responsive to the reasoning input prompt.

16. The method recited in claim 14, wherein the agent creation engine is further configured to determine simulated autonomous agent output data, the simulated autonomous agent output data simulating a result obtained by applying a simulated autonomous agent instance incorporating the autonomous agent definition update information to natural language chat text selected from the database record.

17. The method recited in claim 14, wherein the plurality of database records is sorted in accordance with one or more quality or performance metrics, and wherein the database record is selected based on the one or more quality or performance metrics.

18. The computing services environment recited in claim 14, wherein the autonomous agent definition update information includes a patch implemented in accordance with JavaScript Object Notation, and wherein the agent creation engine is configured to determine the patch by iteratively communicating with the generative language model to determine a proposed patch based on a natural language description of patch information to include in the proposed patch and attempting to apply the proposed patch to a pre-existing autonomous agent definition, wherein the agent creation engine is configured to determine the patch by communicating with the generative language model to evaluate whether the proposed patch accurately reflects the natural language description of patch information to include in the proposed patch.

19. One or more non-transitory computer readable media having instructions stored thereon for performing a method, the method comprising:
storing a plurality of database records in a relational database system, the plurality of database records corresponding to text-based interactions between individuals and human agents;
creating and storing an autonomous agent definition via a an agent creation engine in accordance with a unified metadata framework including a plurality of autonomous agent definitions, the autonomous agent definition being created by iteratively selecting a database record from the plurality of database records and determining autonomous agent definition update information based on text included in the database record, the autonomous agent definition referencing a plurality of action definitions defining a plurality of actions capable of being performed within the computing services environment;
instantiating an autonomous agent instance at an agent service based on the autonomous agent definition; and
determining and executing an orchestration plan at an orchestration layer based on novel planning text generated by a generative language model based on the autonomous agent definition, the orchestration plan including a subset of the plurality of actions identified in the novel planning text, the computing services environment being configured to execute the subset of the plurality of actions.

20. The one or more non-transitory computer readable media recited in claim 19, wherein determining the autonomous agent definition update information comprises:
transmitting a reasoning input prompt to the generative language model, the reasoning input prompt including natural language chat text selected from the database record, the reasoning input prompt also including natural language reasoning instructions to identify one or more modifications to a pre-existing autonomous agent definition based on the natural language chat text; and
determining the autonomous agent definition update information based on novel natural language reasoning output text generated by the generative language model responsive to the reasoning input prompt.
